(19) United States
(12) Patent Application Publication
(10) Pub. No.: US 2014/0162684 A1
(43) Pub. Date: Jun. 12, 2014

(54) Long Term Evolution Advanced Location-Sensitive Information Management

(71) Applicant: AT&T INTELLECTUAL PROPERTY I, LP, Atlanta, GA (US)

(72) Inventor: Venson M. Shaw, Kirkland, WA (US)

(73) Assignee: AT&T Intellectual Property I, LP, Atlanta, GA (US)

(21) Appl. No.: 13/712,369

(22) Filed: Dec. 12, 2012

(51) Int. Cl. H04W 24/00

(52) U.S. Cl. CPC H04W 24/00
USPC 455/456.1

(57) ABSTRACT

LTE advanced location-sensitive information management may include receiving, by a server, location information corresponding to a location of a device that is remote from the server. The server may receive identification information corresponding to a user of the device. The server may organize the location information based on the identification information. The server may receive a list of one or more intended recipients. The server may recommend, based on the identification information, a first time duration during which to expose the location information to the one or more intended recipients. And the server may send the location information to the list of one or more intended recipients.

### TECHNICAL FIELD

The technical field generally relates to wireless communications and more specifically relates to advanced location-sensitive information management systems and methods for use in long term evolution (LTE) networks.

### BACKGROUND

In current wireless networks, such as long term evolution (LTE) networks, the location of a mobile device (also referred to as user equipment or UE) may be provided to third party applications, such as YELP, which may recommend specific subjects, for example restaurants in the surrounding area. As a result, current network systems are extremely limited, in that they fail to provide a systematic approach for a system and method for performing location sensitive information management.

LTE networks may offer significant bandwidth advancement compared with existing 3G and 2G networks. Hundreds of millions of devices may soon communicate with each other leveraging the high bandwidth of LTE networks.

Machine to Machine (M2M) communications are a predominant application for LTE networks. But there remain significant challenges with M2M communications, including auto-pilot communications, whereby M2M communications occur without human intervention; random and unpredictable communications, whereby M2M communications occur spontaneously, at any time, and without forewarning and coordination; and variable volume communications. As a result, without better management systems and methods, M2M communication will result in significant disruption, unpredictable load to the LTE network, and performance degradation and traffic congestion to the conventional user-to-user (U2U) traffic on the LTE network.

### SUMMARY

The following presents a simplified summary that describes some aspects or embodiments of the subject disclosure. This summary is not an extensive overview of the disclosure. Indeed, additional or alternative embodiments of the subject disclosure may be available beyond those described in the summary. The subject disclosure comprises an LTE advanced location-sensitive information management system and method. The system and method may comprise one or more of the steps of receiving, by a server, location information corresponding to a location of a device that is remote from the server, the server further receiving identification information corresponding to a user of the device; organizing or categorizing, by the server, the location information based on the identification information; receiving, by the server, a list of one or more intended recipients; recommending, by the server, based on the identification information, a first time duration during which to expose the location information to the one or more intended recipients; and sending, by the server, the location information to the list of one or more intended recipients.

According to another aspect of the disclosure, an intelligent M2M communications system and method comprises one of more steps of: systematically organizing M2M communications traffic according to one or more of event type, venue, device profile, device application; teaching the M2M message header comprising one or more of source/destination address, source/destination machine type, message priority, performance requirement, and time stamp; and teaching the M2M controller to perform one or more of identifying the device's location, querying the device's current and/or upcoming activity, querying the device's profile, and granting a selective plurality of devices permission rights for M2M communications.

### BRIEF DESCRIPTION OF THE DRAWINGS

The following detailed description of example embodiments is better understood when read in conjunction with the appended drawings. For the purposes of illustration, there is shown in the drawings exemplary embodiments; however, the subject matter is not limited to the specific elements and instrumentalities disclosed. In the drawings:

FIG. 1 is a schematic diagram of a location sensitive information system.

FIG. 1A is a system diagram of an example communications system in which LTE advanced location-sensitive information management methods and systems may be implemented.

FIG. 1B is a system diagram of an example mobile device (also referred to as a wireless transmit/receive unit (WTRU) and/or as user equipment (UE)) that may be used within the communications system illustrated in FIG. 1A.

FIG. 1C is a system diagram of an example radio access network and an example core network that may be used within the communications system illustrated in FIG. 1A.

FIG. 2 is a schematic diagram illustrating LTE advanced location-sensitive information management systems and methods of the present disclosure.

FIG. 2A illustrates a non-limiting exemplary network configuration in which LTE advanced location-sensitive information management methods and systems may be implemented.

FIG. 3 illustrates a non-limiting exemplary method of implementing LTE advanced location-sensitive information management methods and systems.

FIG. 4 is a block diagram of a non-limiting exemplary mobile device in which LTE advanced location-sensitive information management methods and systems may be implemented.

FIG. 5 is a block diagram of a non-limiting exemplary processor in which LTE advanced location-sensitive information management methods and systems may be implemented.

FIG. 6 is a block diagram of a non-limiting exemplary packet-based mobile cellular network environment, such as a GPRS network, in which LTE advanced location-sensitive information management methods and systems may be implemented.

FIG. 7 illustrates a non-limiting exemplary architecture of a typical GPRS network, segmented into four groups, in which LTE advanced location-sensitive information management methods and systems may be implemented.

FIG. 8 illustrates a non-limiting alternate block diagram of an exemplary GSM/GPRS/IP multimedia network architecture in which LTE advanced location-sensitive information management methods and systems may be implemented.

FIG. 9 illustrates a PLMN block diagram view of an example architecture in which LTE advanced location-sensitive information management methods and systems may be incorporated.

FIG. 10 illustrates a non-limiting exemplary LTE advanced location-sensitive information management method and system of the present disclosure.

FIG. 11 illustrates another non-limiting exemplary LTE advanced location-sensitive information management method and system of the present disclosure.

FIG. 12 illustrates another non-limiting exemplary LTE advanced location-sensitive information management method and system of the present disclosure.

FIG. 13 illustrates another non-limiting exemplary LTE advanced location-sensitive information management method and system of the present disclosure.

### DETAILED DESCRIPTION OF ILLUSTRATIVE EMBODIMENTS

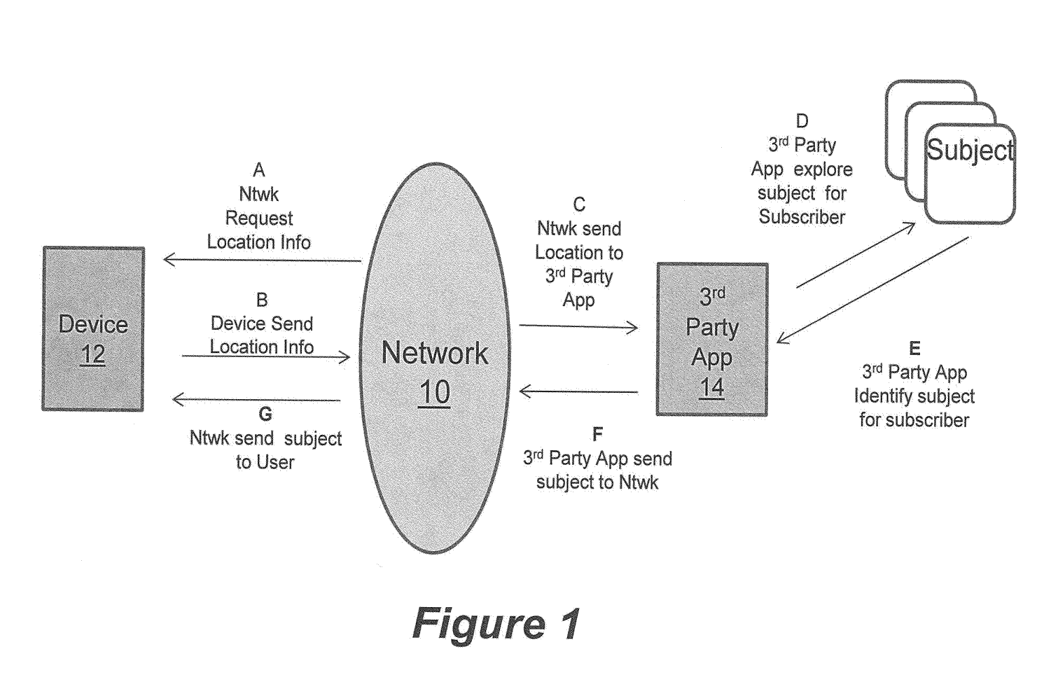

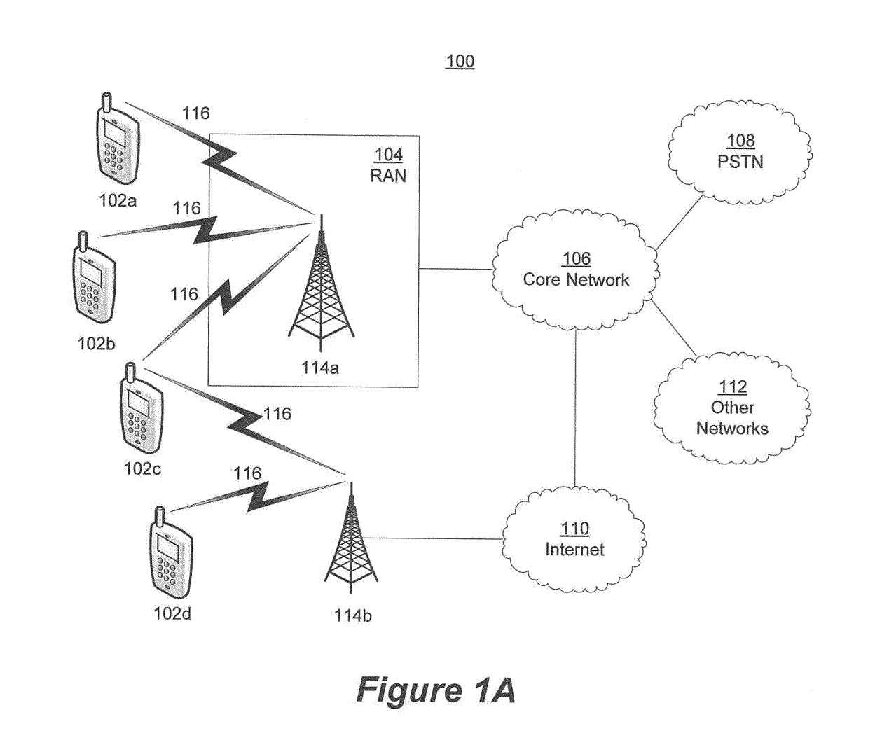

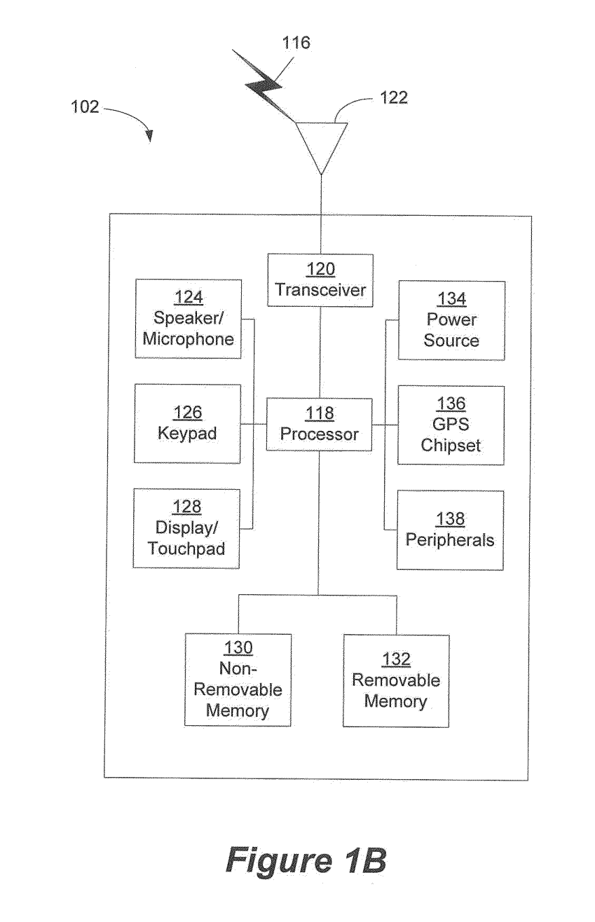

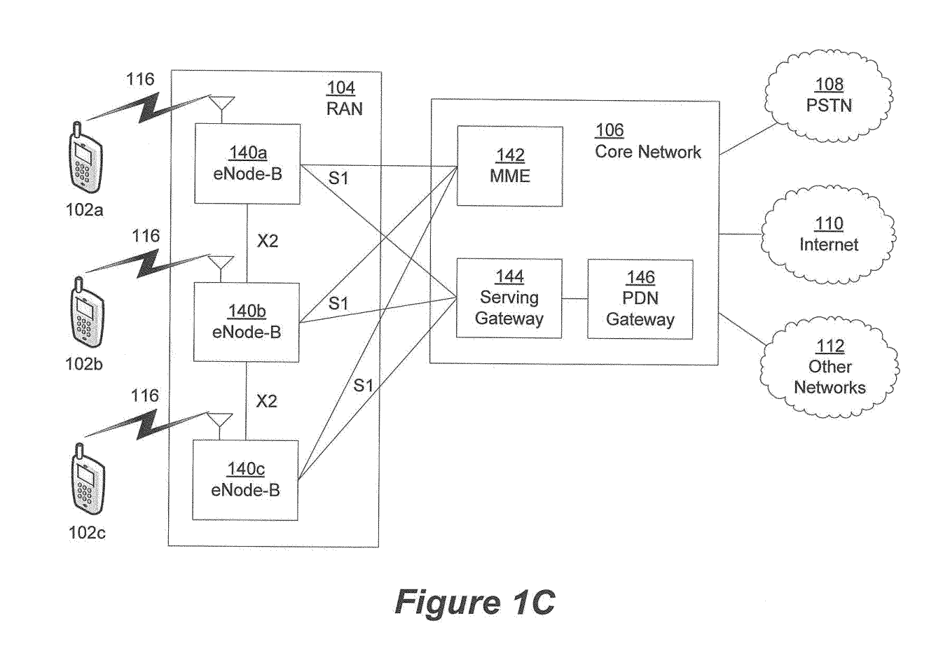

FIG. 1 is a schematic diagram of a location sensitive information management system. As illustrated, such systems may use a network 10 to request location information at step A from a subscriber or user's device 12, for example a handheld device such as a mobile phone. The device 12 then may then, at step B, send location information back to the network 10, which in turn may transmit the location information at step C to a third party application 14. The third party application 14 may then explore, at step D, and then identify, at step E, a subject 16 for the subscriber. The third party application 14 may then, at step F, transmit the subject information to the network 10, which in turn may, at step G, relay the subject to the user's device 12. Accordingly, such location sensitive information systems typically use the network 10 merely as a conduit for passing information back and forth between the subscriber and the third party application.

There are numerous shortcomings with such systems. For example, such systems generally only provide the user's current location to specific third party applications, e.g., YELP or Groupon, which in turn allow the third party application to recommend specific subjects, such as restaurants, proximate the user's location to the user. Such systems, however, do not generally allow the relevant server to manage and update the corresponding location information for each subscriber, to distribute the location information to a specific list of recipients per the subscriber's request, to distribute the location information per the subscriber's request during a specific time duration, to recommend a time duration based on the subscriber's profile for the subscriber to share his or her location without request, to enforce “privacy” for the subscriber to enable or disable sending location information to other recipients per the subscriber's request, and/or to enforce “sharing” for subscribers to share location information with each other per mutual consent from subscribers.

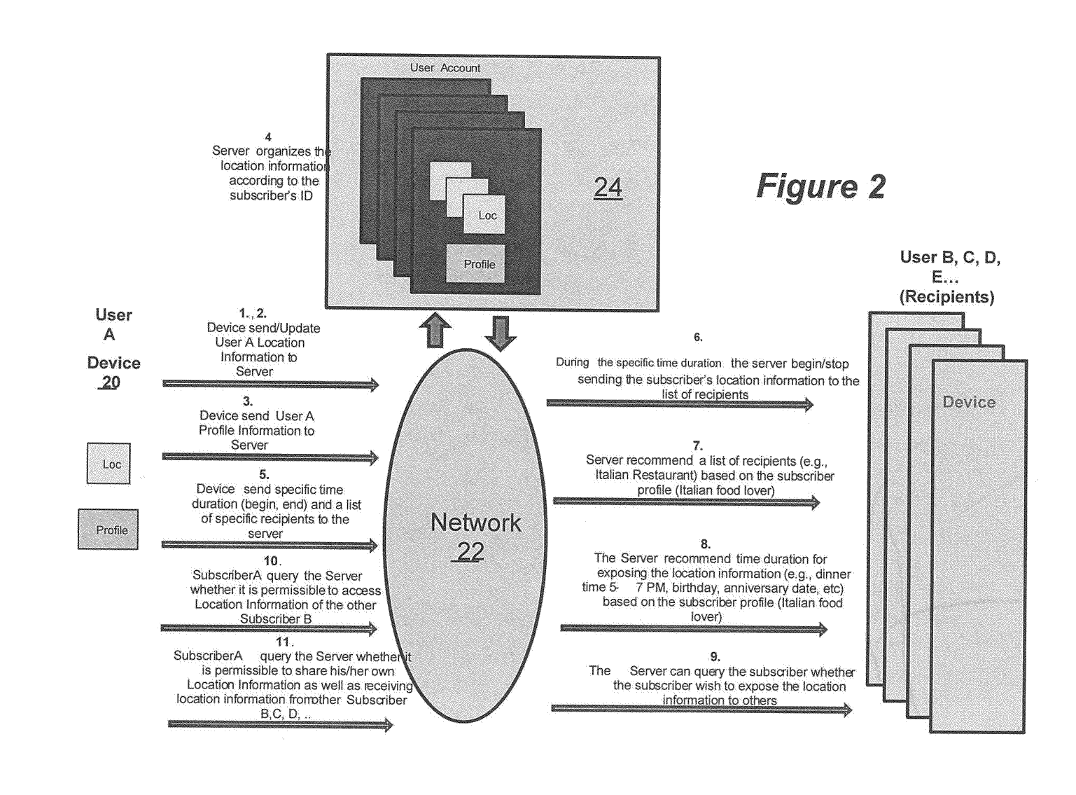

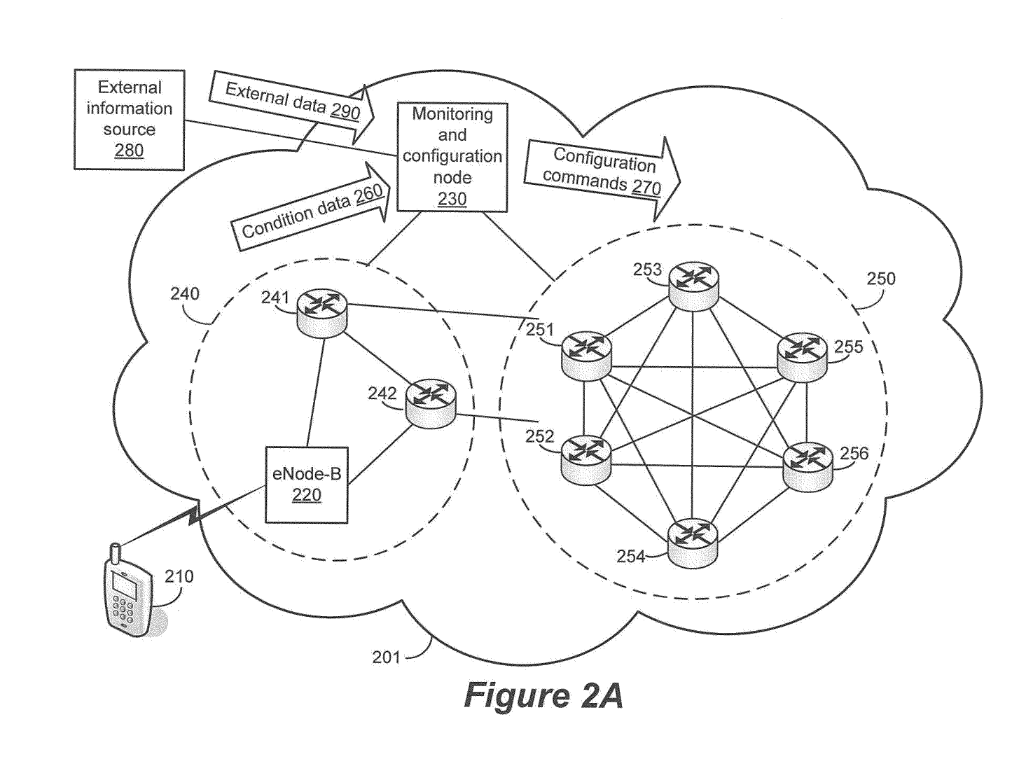

FIG. 2 is a schematic diagram illustrating location sensitive information management systems and methods of the present disclosure. According to a preferred embodiment, a subscriber or user of a device 20, which may be a communications device, may send location information at step 1 to a network 22 that may be an LTE network that communicates with a server 24. As will be understood, as used herein, the terms “user,” “subscriber,” and “recipient” may be used interchangeably, depending on the context, as a “subscriber” to telecommunications services man be a “user” of a handheld device 20 for using such services, and may further be a “recipient” of information from the server 24 while using such services. As will also be understood, where the device 20 is a portable device, such as a handheld cellular phone, i-Pad, i-Phone, etc., the location of the device 20 may directly or generally correspond with the location of the recipient, user, or subscriber who may be in proximity with the device. The device 20 may send updated location information in one or more subsequent steps, at step 2.

In step 3, the device 20 may send the device user/subscriber's profile information, in this case for User A, to the network or server 24. The user's profile information may include, for example, the user's identification, preferences (such as food, clothing, books, movies, TV shows, sports teams, etc.), contacts, age, birthday, address, etc.

The server 24 may then organize the location information for the user/subscriber according to the user profile information at step 4. For example, if the user's profile indicates a preference for Italian restaurants, the server 24 may organize the user's location information according to Italian restaurants proximate the user's current location. As another example, if the user's profile includes contacts information, the server may organize the user's current location information according to the user's proximity to his or her contacts' locations.

At step 5, the device 20 may be enabled with a time duration feature that may include a start time and an end time. The time duration feature may, during a specific time duration, which the user may specify, send a list of recipients to the server 24. For example, the user may wish to learn of possible restaurant availability for an upcoming event, such as a birthday. The user may specify, with the device, that a list of recipient restaurants be polled for available seating times starting, for example, a week before the birthday and ending the day before the birthday.

The server 24 may then, at step 6, begin sending the subscriber's location information during the specific time duration to a list of one or more intended recipients, identified as Users B, C, D, E . . . in FIG. 2. The server may distribute the subscriber's location information and do so during the specific time duration at the subscriber's request. As used herein, “time duration” generally means a period of time defined by a start time and an end time.

At step 7, the server may recommend a list of intended recipients to receive the subscriber's location information based on the subscriber's profile. The server may make this recommendation without the subscriber's request. Alternatively, the subscriber may recommend to the server a desired list of one or more intended recipients to whom to send the subscriber's location information.

As an example, a subscriber may be at a sporting or other event that is about to being in one hour, and may need a ticket for the event. The subscriber may initiate the time duration feature to start, enabling the server to send a request for tickets and the subscriber's current location to a list of known or possible ticket sellers. The subscriber may indicate that the request only remain extant for the next hour, i.e., until the event is set to begin.

As another example, the system and method of the disclosure may serve a “matchmaking” function, permitting a subscriber to locate other subscribers to arrange for the subscribers to meet one another. This function may be best implemented using the “privacy” and “sharing” features discussed subsequently.

At step 8, the server 24 may recommend a time duration (which may be the same or different from the time duration of step 5) for exposing the subscriber's location information to a list of intended recipients, based on the subscriber's profile. The server may make this recommendation without the subscriber's request. For example, the server 24 may know from the subscriber's profile that the subscriber prefers Italian restaurants and prefers to go out to dinner on Saturday evenings between 5 and 7 p.m. Accordingly, the server 24 may, during that time period, expose the subscriber's location information to Italian restaurants that are proximate the subscriber during that two-hour time window. As another example, the server may know that the subscriber's spouse's birthday is one week hence, and the subscriber may have previously instructed the server to initiate a one week time “window” for reminding the subscriber to make dinner reservations during that one week time window, according to the subscriber's (or the spouse's) preferences and/or location information.

At step 9, the server 24 may optionally query the subscriber as to whether the subscriber wishes to expose the subscriber's location information, either to the list of intended recipients or other possible recipients.

As another option, shown as step 10, the subscriber “A” may send a query to the server 24 seeking permission to access location information for another subscriber, i.e., subscriber “B.” Using the above example, subscriber “B” may be a ticket seller, and subscriber “A” may wish to locate subscriber “B” in order to purchase a ticket to an event, for example, outside a theater, near a stadium, or in a parking lot. The server may be able, using GPS positioning, to locate subscriber “B's” precise location and send subscriber “A” a map or other positioning information to allow subscriber “A” to physically migrate to subscriber “B's” location to complete the transaction.

Yet another option, illustrated at step 11, may be for subscriber “A” to query the server 24 seeking permission to share subscriber “A's” location information with, and/or receive from one or more other subscribers, “B”, “C”, “D”, . . . etc., their respective location information.

Yet another option that the system of the present disclosure provides may include confirmation, and/or cancellation features. For example, the server 24 may recommend a list of intended recipients, e.g., Italian restaurants, based on the subscriber's profile indicating a preference for Italian food. According to one option, the system may require the subscriber to confirm that the subscriber wants the server 24 to start sending the subscriber's location information to the list of intended recipients. This option may further include a cancellation feature, whereby the subscriber may instruct the server 24 to stop sending the subscriber's location information to the list of intended recipients, or to a targeted subset of intended recipients. This same feature, i.e., confirmation and/or cancellation, may also be used for initiating and terminating the time duration window during which the subscriber's location information may be exposed to the list of intended recipients.

As another example, subscriber “A” may query the server 24 seeking permission to access location information of another subscriber “B”. In this scenario, the server may query subscriber “B” for authorization to expose subscriber “B's” location information to subscriber “A”. Subscriber “B” may then grant such authorization to the server 24 by sending a confirmation and thereby granting the server permission to start sending subscriber “B's” location information to subscriber “A”. Subscriber “B” may also have, through a user device 20, the ability to send the server 24 a cancellation instruction, whereupon the server 24 may stop sending subscriber “B's” location information to subscriber “B”.

According to another embodiment, the confirmation/cancellation features may permit subscriber “A” to query the server 24 for permission to share subscriber “A's” location information with, and/or receive location information from, one or more other subscribers, “B”, “C”, “D”, . . . etc. The server 24 may send a query seeking such permission from such one or more other subscribers, and upon receiving confirmation, e.g., from subscriber “B,” may start sending subscriber “B's” location information to subscriber “A”, and start sending subscriber “A's” location information to subscriber “B.” The one or more other subscribers, e.g., subscriber “B” may subsequently send the server 24 a cancellation instruction, whereupon the server 24 may stop sending the subscriber “B” location information to subscriber “A”, and stop sending the subscriber “A” location information to subscriber “B”.

The system and method of the present disclosure may thus allow subscribers to locate establishments, such as restaurants and stores, individuals, such as friends and family, and sellers of merchandise or services, or other intended recipients or providers of information, products, and/or services.

The system and method of the present disclosure may also optionally include a sharing feature. The sharing feature may enable multiple users to share location information of each respective user with other users, with the mutual consent of each user.

The system and method of the present disclosure may also optionally include a privacy setting feature that may enable the subscriber to prevent the subscriber's location information from being disclosed to recipients without prior authorization. According to this option, the server 24 may query the subscriber seeking permission to expose the subscriber's location to others, i.e., to other subscribers, to a list of intended recipients, to friends, etc. If the server 24 receives confirmation from the subscriber granting the server 24 authorization to expose the subscriber's location information, the server 24 may disable the privacy setting and start sending the subscriber's location information. If on the other hand, the subscriber does not grant such authorization, the system may prevent the server 24 from sending the subscriber's location information. If the subscriber gives the server 24 confirmation instructions to start exposing the subscriber's location information, and the server 24 then receives a cancellation instruction from the subscriber, the server 24 may then turn the privacy setting back on, and stop sending the subscriber's location information.

The server 24 may be granted a privacy override feature in certain special circumstances, for example, in the case of a law enforcement scenario, as discussed below, or where, based on the facts and circumstances, a subscriber is suspected of being in duress and/or unresponsive from an emergency situation such as a medical emergency, traffic accident, a criminal assault, i.e., home invasion or carjacking, natural disaster, fire, flood, etc. In such cases, the server 24 may be enabled to override the privacy feature in order to permit law enforcement, emergency rescue, EMT, and/or medical personnel to locate the subscriber.

The system and method of the present disclosure may also be advantageously used by law enforcement authorities to track possible transactions of illicit substances and/or activities, and lead them to the precise location where such transactions are taking place or are about to take place, in order to apprehend the suspected perpetrator(s). The server 24 may also be coded to grant location permission to law enforcement authorities or emergency responders without obtaining permission from the suspected perpetrator(s) or individual in need of emergency attention, particularly if the authorities have a search warrant and/or a warrant for the apprehension of the suspected perpetrator(s), or the emergency responders can demonstrate that the subscriber is nonresponsive. In the case of tracking suspected perpetrators engaging in criminal activity, or subscribers experiencing a medical emergency, the time duration “window” for tracking such subscribers might be set to correspond to known crime or medical emergency “windows” in areas of interest. For example, both criminal activity and serious traffic accidents tend to occur late at night or in the early morning hours.

The system and method of the present disclosure may also comprise a computer-readable storage medium comprising executable instructions that when executed by a processor cause the processor to effectuate operations comprising:
a) receiving, by a server, location information corresponding to a location of a device that is remote from the server, and further receiving identification information corresponding to a user of the device;
b) organizing or categorizing, by the server, the location information based on the identification information;
c) receiving, by the server, a list of one or more intended recipients;
d) recommending, by the server, based on the identification information, one or more targeted recipients of the location information from the list of one or more intended recipients, and further recommending, by the server, a first time duration during which to expose the location information to the one or more targeted recipients, based on the identification information; and
e) sending, by the server, the location information to the list of one or more intended recipients.

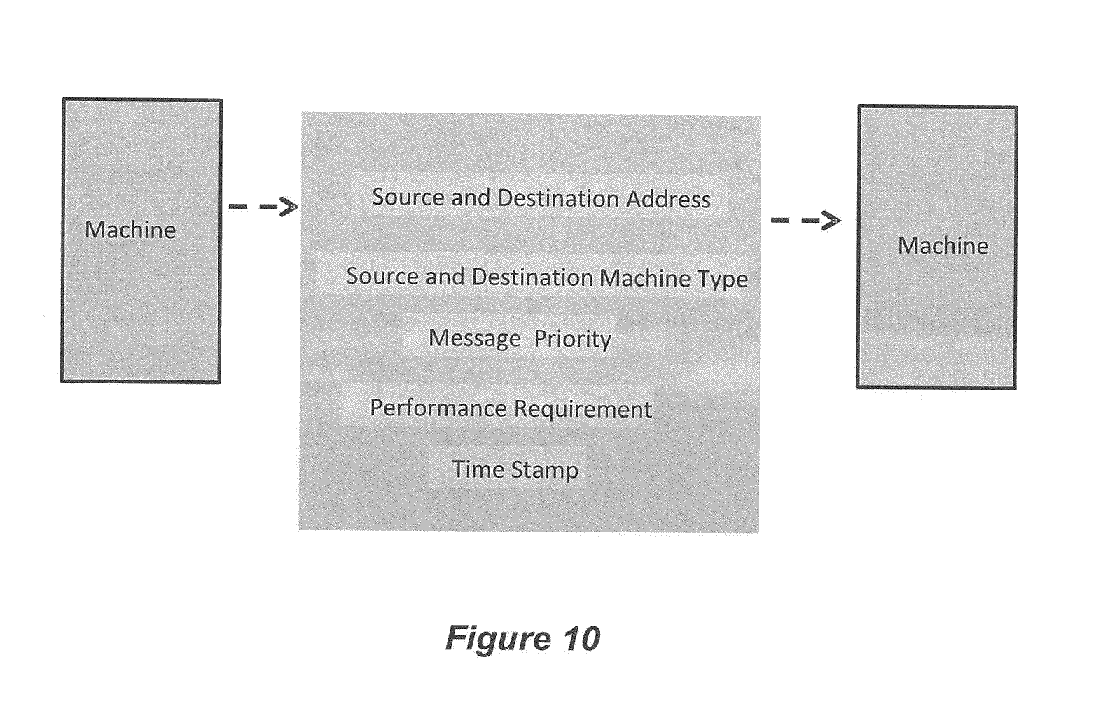

According to another aspect of the disclosure, illustrated in FIG. 10, an LTE intelligent M2M communications system and method, with the M2M messaging comprising one of more steps of: teaching the M2M message header comprising one or more of source/destination address, source/destination machine type (e.g., home, auto, appliance, etc.), message priority (e.g., high, medium, low), performance requirement (e.g., real time, near-real time, non-real time), and time stamp; and teaching the M2M controller to perform one or more of identifying the device's location, querying the device's current and/or upcoming activity, querying the device's profile, and granting a selective plurality of devices permission rights for M2M communications.

For lower priority and non-real time traffic, messages may be collected at the M2M controller and delivered to the corresponding destination address at a later appropriate time. For high priority and real time traffic messages may be delivered immediately to the corresponding destination. For remote communications with devices outside of the home area, the originating M2M controller may aggregate the total traffic from multiple devices and deliver them to the target area of the destination device. Upon reaching the target area, the destination M2M controller may disassemble the M2M traffic and deliver the traffic to each of the destination machine devices.

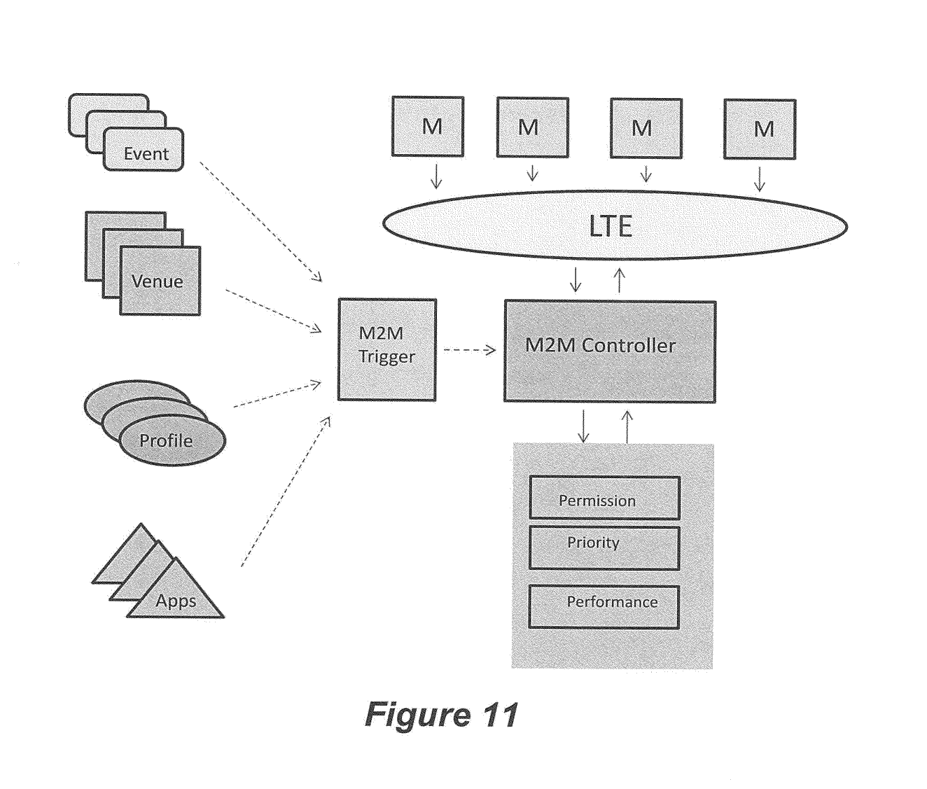

According to another aspect of the present disclosure, as illustrated in FIG. 11, there may be provided an intelligent M2M communications system and method including an M2M controller that communicates with an LTE, the LTE communicating with one or more machine users “M.” In this embodiment, the M2M controller may systematically organize the M2M communications traffic according to one or more of event types (festivals, conferences, etc.), venues (home, office, vacation, sports complex, etc.), device profiles (consumer, enterprise, etc.), and/or device applications (air conditioner, microwave, refrigerator, etc.).

As illustrated, the M2M controller may comprise and/or communicate with an M2M trigger, which in turn may store or otherwise access time-dependent data, such as upcoming events, venues, user profiles, and third party applications. Upon being triggered, for example, by an upcoming event such as a theater performance, the M2M trigger may notify the M2M controller of the event. The M2M controller, in turn, may include permission, priority, and/or performance features that may, for example, assist in prioritizing which triggers from the M2M trigger are to be acted upon first and in what order, may govern and manage permission features, such as which of the numerous device users “M”, with whom the M2M controller communicates through the LTE, have given permission to receive such notification, and may manage performance features, such as determining whether the data needs to be sent in real-time, near-real time, or non-real-time.

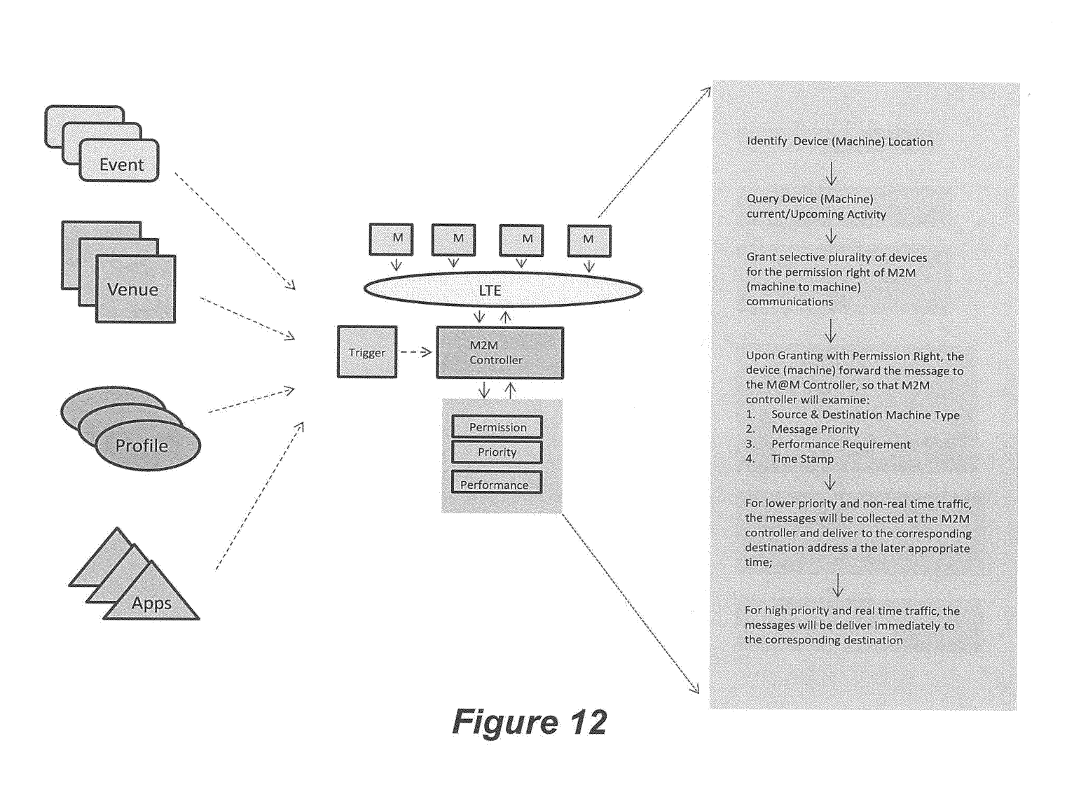

According to yet another aspect of the present disclosure, as illustrated in FIG. 12, there may be provided an intelligent M2M communications system and method, i.e., for M2M home communications. In the embodiment illustrated, a home network may include multiple machines or devices “M”, in communication with the LTE network. The LTE network, in turn, may be in communication with an originating M2M controller that may be triggered by one or more of an event, a venue, a profile, or a third party application, whereupon an M2M controller may identify the device (machine) “M's” location, query the device's current location and/or upcoming activity, query the device's and/or the device user's profile, and/or grant a selective plurality of devices permission rights to M2M communications. Upon granting such permission rights, the device may forward the message to the M2M controller so that the controller may examine one or more of the source and/or destination machine type (e.g. home, auto, appliance, electronic, etc.), message priority (e.g., high, medium, low), performance requirement (e.g., real time, near-real time, non-real time), and time stamp.

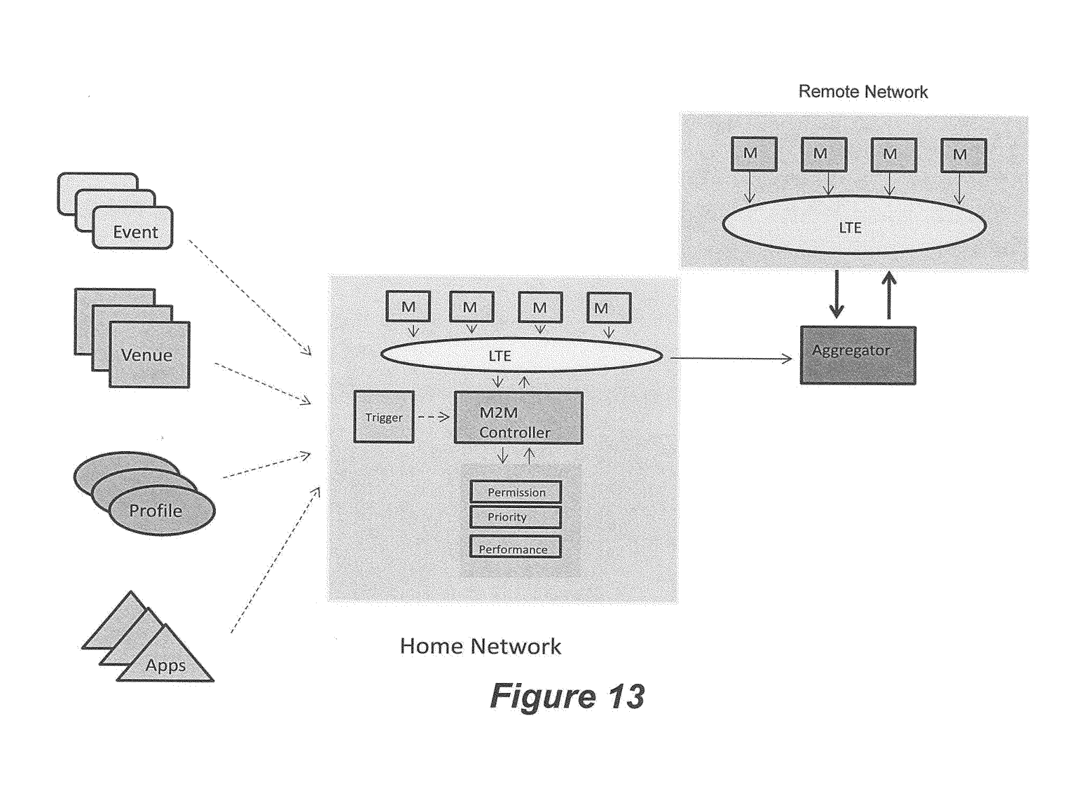

According to yet another aspect of the present disclosure, illustrated in FIG. 13, there may be provided a system and method for M2M remote communications. This system may, as illustrated, comprise a home network comprising a first LTE network in communication with a plurality of home devices, the home network further comprising a machine-to-machine controller in communication with the first LTE network, the machine-to-machine controller comprising a trigger that can cause the machine-to-machine controller to send time sensitive data, at a predetermined time, to one or more of the plurality of home devices through the first LTE network; a remote network comprising a second LTE network which may be the same or different from the first LTE network, the second LTE network in communication with a plurality of remote devices; and an aggregator in communication with both the first LTE network and the second LTE network. The aggregator may aggregate data, such as total traffic, from the plurality of home devices to yield aggregated data, and may deliver the aggregated data to one or more of the remote devices. The system may further comprise a remote network machine-to-machine controller that can disassemble the aggregated data to yield disassembled data, and may deliver the disassembled data, such as traffic, to a target area of the one or more remote devices.

The system may thus comprise the steps of the originating M2M controller aggregating the total traffic from multiple devices and delivering messages from devices outside of the home area to the target area of the destination device, and, upon reaching the target area, the destination M2M controller may disassemble the M2M traffic and deliver the traffic to each of the destination machine devices. In the embodiment illustrated, a home network may include multiple machines or devices “M”, in communication with the LTE network. The LTE network, in turn, may be in communication with an originating M2M controller that may be triggered by one or more of an event, a venue, a profile, or a third party application, to send a message to a remote network. The M2M controller, in turn, may be in communication with permission, priority, and/or performance modules that may assist in prioritizing and/or organizing the outgoing communications, which may be sent to an aggregator as illustrated. The aggregator, in turn, may communicate with a remote LTE network and remote machines or devices “M”.

The system and method of the present disclosure may include one or more hardware, software, and/or firmware components to enable the steps described herein to be performed. Such components may be built into the LTE core network elements and supplied by manufacturers such as Alcatel-Lucent, Cisco Systems, and Ericsson. Additionally, the devices used in practicing the systems and methods described herein may advantageously leverage OMA and OMTP International Standards for iPhone, RIM, and other mobile devices according to the individual device manufacturer requirements. The system and methods of the present disclosure may be incorporated into the 3GPP, IETF, OMA, and OMTP International Standards for LTE and Wireless Network. Worldwide operators, server and device manufacturers must comply and use the methods and systems described herein to permit inter-operability among each other. Furthermore, the system and method of the present disclosure may leverage the OMTP International Standards to allow a universal LE Wireless Network Location Management server to manage multiple clients either locally or remotely.

FIG. 1A is a diagram of an example communications system 100 in which LTE advanced location-sensitive information management systems and methods as disclosed herein may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. A communications system such as that shown in FIG. 1A may also be referred to herein as a network.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a mobile device, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA) that may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATS, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, and 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, and 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway or entity (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode-Bs 140a, 140b, and 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 2A illustrates an exemplary network configuration and signal flow that may be used in an embodiment. Mobile device 210, in an embodiment operated by a customer of a provider of network 201, may be in communication with network 201 via eNode-B 220. Mobile device 210 may be any type of wireless communications device, including a UE, a WTRU, or any other communications device as disclosed herein, or any other type of device capable of being configured to perform the functions and features of the present disclosure. Network 201 may be any type of communications network, including a wireless network, a wired network, and a combination thereof, implementing any number and type of communications protocols and technologies. eNode-B 220 may be in radio access network (RAN) 240 portion of network 201 and may be any type of eNode-B or any other type of RAN device or edge device, and represents any device capable of performing the functions and activities described herein. All such embodiments are contemplated as within the scope of the present disclosure.

RAN 240 may include devices 241 and 242 that may be any type of RAN devices. RAN 240 and/or devices therein may be communicatively connected to core network 250. Core network 250 may include devices 251, 252, 253, 254, 255, and 256, which may be any type of network device, element, or system that may be configured in a core network. Monitoring and configuration node 230 may be communicatively connected to both RAN 240 and core network 250, and maybe any number and type of devices configured to implement any aspect of the present disclosure.

Monitoring and configuration node 230 may receive condition data 260 from either or both RAN 240 and core network 250. Condition data 260 may also be provided, or retrieved from, network systems such as network performance management systems and operational support systems (OSS) that may provide counters, alarms, errors, etc. that may be included in condition data 260. Condition data 260 may include information from devices operating at any layer of a network, including LTE devices such as policy charging and rules function (PCRF) devices, multiprotocol label switching (MPLS) devices, etc. Condition data may be received in-band or out-of-band. Condition data 260 represents any and all condition data or other data described herein, and any number of transmissions of such data and any form of reporting such data, that may be sent from any device, element, or system in any portion of network 201, including RAN 240 and 250. In an embodiment, monitoring and configuration node 230 may be directly connected to each device from which it receives condition data and/or may maintain virtual or logical connections to such devices. Alternatively, monitoring and configuration node 230 may receive aggregated condition data representing condition data for more than one device that has been aggregated by one or more devices and sent on behalf of a plurality of devices. All such embodiments are contemplated as within the scope of the present disclosure.

In an embodiment, each node within network 201, or within a portion of network 201, may transmit condition data to monitoring and configuration node 230. Each node may be configured to transmit such data on a periodic basis, based on some condition criterion being met, or upon any or predetermined changes in device and/or link conditions. For example, a node such as device 253 may be configured to transmit condition data to monitoring and configuration node 230 every minute. Alternatively, device 253 may be configured to transmit condition data to monitoring and configuration node 230 any time a condition on or detectable by the device meets a threshold or other condition (e.g., a link attached to device 253 exceeds a threshold of utilization, a processor on device 253 exceeds a threshold of utilization, the amount of traffic processed by device 253 exceed a threshold, etc.). Alternatively, device 253 may be configured to transmit condition data to monitoring and configuration node 230 when any condition on the device changes or changes significantly. For example, processor utilization or a link utilization increasing by more than a predetermined threshold may trigger a condition data transmission. Any other criteria or configuration may be used to determine when and how condition data is transmitted to monitoring and configuration node 230, and all such embodiments are contemplated as within the scope of the present disclosure.

Using the condition data received at monitoring and configuration node 230, this node may analyze the condition of the network, or the portion of the network for which condition data has been received, as a whole to determine whether any configuration changes should be made. If the condition data as analyzed indicates that there are adverse or less than ideal conditions in the network that may be addressed by reconfiguration of devices within the network, or that adverse or less than ideal conditions are likely to occur if no reconfiguration is performed (i.e., predicting future adverse conditions), monitoring and configuration node 230 may then transmit configuration commands 270 to one or more devices in network 201. Configuration commands 270 represents any and all configuration commands or any other commands described herein, and any number of transmissions of such commands and any form of providing such commands that may be sent from monitoring and configuration node 230 to any device, element, or system in any portion of network 201 including RAN 240 and 250.

In an embodiment, configuration commands 270 may include commands that instruct network devices within network 201 to redirect traffic from highly congested network nodes, links and/or areas to less congested network nodes, links and/or areas. Such commands may also, or instead, instruct one or more network devices within network 201 to re-provision network capacity to increase traffic capacity for highly congested network nodes, links and/or areas and/or reducing traffic capacity for less congested network nodes, links and/or areas. In another embodiment, configuration commands 270 may include commands that instruct network devices within network 201 relax delivery time requirements for traffic (e.g., changing delivery requirements of such traffic from real-time requirements to non-real-time requirements) for service delivery in highly congested network nodes, links and/or areas and/or tighten delivery time requirements (e g., changing delivery requirements of such traffic from non-real-time requirements to real-time requirements) for service delivery in less congested network nodes, links and/or areas. In another embodiment, configuration commands 270 may include commands that instruct network devices within network 201 redirect network traffic with real-time delivery requirements to less congested network nodes, links and/or areas, and/or redirect network traffic with non-real-time delivery requirements to more congested network nodes, links and/or areas.

Condition data taken into account and/or analyzed by a device such as monitoring and configuration node 230 may include any type of utilization and/or congestion data for devices, device components, and virtual and/or physical links between devices. Condition data may also include any indications of the types of traffic being transported across a network or portion of a network (e.g., the protocol used in any portion of the traffic) and the requirements of such traffic (e.g., quality of service parameters). All types and forms of condition data that may indicate any condition of a network element, link, portion, or area are contemplated as within the scope of the present disclosure.

In an embodiment, condition data may be received by a device such as monitoring and configuration node 230 in response to probing activities by monitoring and configuration node 230. For example, rather than devices within network 201 being configured to transmit condition data to monitoring and configuration node 230, monitoring and configuration node 230 may be configured to probe such devices for the data. Monitoring and configuration node 230 may transmit queries or polling requests to network devices in order to obtain condition data. Such probing may be passive in that the probed devices are not specifically configured to interact with monitoring and configuration node 230, but rather monitoring and configuration node 230 may use existing methods or means for obtaining condition information, such as already existent reporting mechanisms configured on network devices. Alternatively, devices within network 201 may not be configured to transmit condition data to monitoring and configuration node 230 proactively, but may instead be configured specifically to respond to queries from monitoring and configuration node 230 for such data. All such embodiments are contemplated as within the scope of the present disclosure.

In an embodiment, monitoring and configuration node 230 may receive external data 290 regarding events that are occurring or have occurred external to network 201. For example, monitoring and configuration node 230 may receive natural disaster data from an emergency services agency. Alternatively, external data 290 may be news, media, or any other information that may be received by monitoring and configuration node 230. External data 290 may be received from external information source 280, which may be any device, system, entity, or any combination and number thereof, that may be configured to provide event data to monitoring and configuration node 230.

In response to receiving external data 290, monitoring and configuration node 230 may transmit configuration commands 270 to reconfigure one or more network elements. For example, if external data 290 indicates that an area of network 201 is likely to be affected by a natural disaster, monitoring and configuration node 230 may transmit configuration commands 270 to elements in network 201 that cause those elements to route traffic around that area. This may help avoid outages and deterioration of service by routing traffic around a potential problem area of the network before an actual problem arises.

In an embodiment, policies may be used based on external data 290 and/or condition data 260. For example, characteristics of an event such as a type, location, track or trajectory (e.g., of a storm, hurricane, etc.), probability of occurrence, population impact, customer impact, duration, technology impact, second order effects, third order effects, etc. of an event may be compared to policies configured on monitoring and configuration node 230 in order to determine the appropriate configuration commands 270 to provide to network devices. By using such policies and/or rules, flexibility and dynamic response to events and network conditions may be integrated into a device or system such as monitoring and configuration node 230, allowing it to more quickly and effectively change the network configuration to provide better service. Differences in time scale (e.g., speed of response, polling, probing, etc.) may be implemented in response to a policy determination as may be changes in granularity and automation (e.g., types and frequency of condition and event data used and/or received by monitoring and configuration node 230). Any policies in use may allow for staging of other policies in preparation for condition and/or event changes and may also allow for reconfiguration of policies as an event or condition continues.

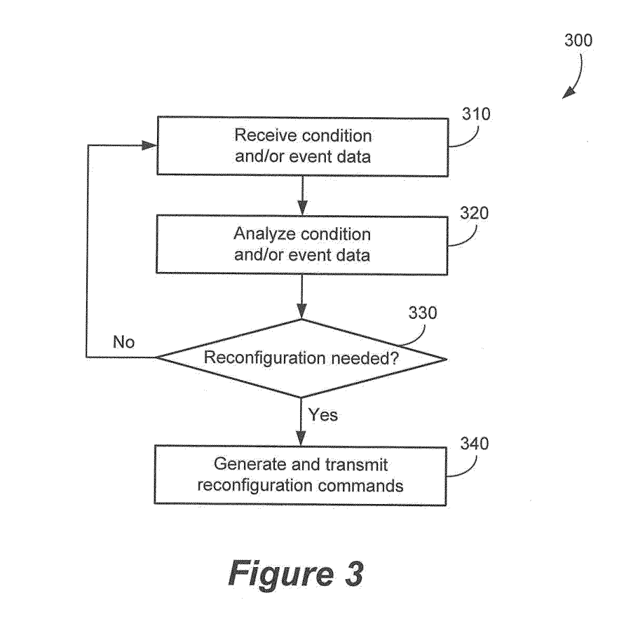

FIG. 3 illustrates exemplary, non-limiting method 300 of implementing an embodiment as disclosed herein. Method 300, and the individual actions and functions described in method 300, may be performed by any one or more devices, including those described herein. In an embodiment, method 300 may be performed by a device such as monitoring and configuration node 230, in some embodiments in conjunction with other network elements, and/or software configured and/or executing on any network element. Note that any of the functions and/or actions described in regard to any of the blocks of method 300 may be performed in any order, in isolation, with a subset of other functions and/or actions described in regard to any of the other blocks of method 300 or any other method described herein, and in combination with other functions and/or actions, including those described herein and those not set forth herein. All such embodiments are contemplated as within the scope of the present disclosure.

At block 310, condition data and/or event data may be received at a monitoring and configuration node. This data may be any type of data as described herein, or any other data that may be used to determine whether and how to configure a network. At block 320, the data received may be analyzed to determine whether network changes are to be made. Such analysis may include any analysis set forth herein or any other analysis that may be performed in network management. At block 330, a determination may be made as to whether any network reconfiguration should be performed in order to improve the performance of the network, or avoid future degradation of the network, in light of the data received at block 310 and the analysis performed at block 320. If no reconfiguration is needed, condition and/or event data may be further received at block 310. If reconfiguration is needed, at block 340 the appropriate reconfiguration commands may be determined, generated, and transmitted to the appropriate recipient devices.

The LTE advanced location-sensitive information management methods and systems described above assist in providing improved customer service by addressing network performance affecting uses quickly, automatically, and efficiently. By implementing the present disclosure, the user experience may be improved by correcting service problems quickly and avoiding other problems altogether. Set forth below are further exemplary systems, devices, and components in which aspects of the disclosed LTE advanced location-sensitive information management methods and systems may be implemented.

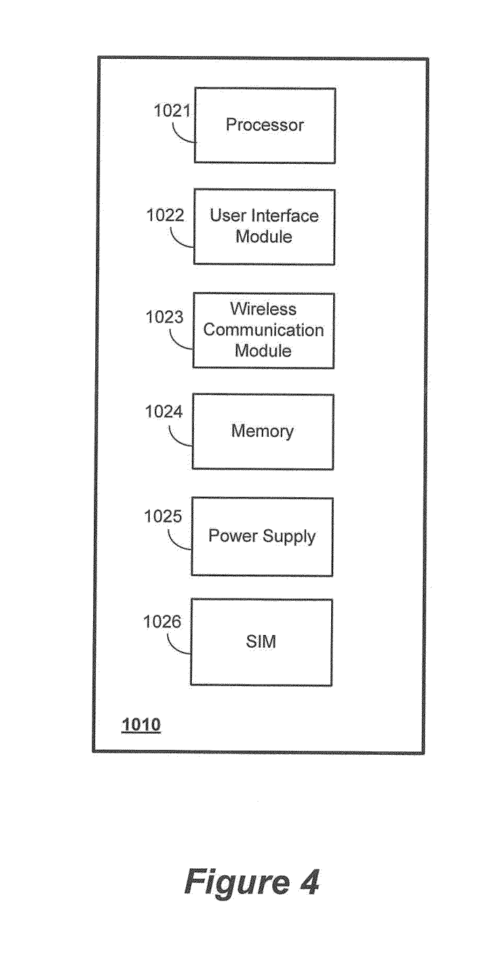

FIG. 4 illustrates an example wireless device 1010 that may be used in connection with an embodiment. References will also be made to other figures of the present disclosure as appropriate. For example, mobile devices 102 and 210 may be wireless devices of the type described in regard to FIG. 4, and may have some, all, or none of the components and modules described in regard to FIG. 4. It will be appreciated that the components and modules of wireless device 1010 illustrated in FIG. 4 are illustrative, and that any number and type of components and/or modules may be present in wireless device 1010. In addition, the functions performed by any or all of the components and modules illustrated in FIG. 4 may be performed by any number of physical components. Thus, it is possible that in some embodiments the functionality of more than one component and/or module illustrated in FIG. 4 may be performed by any number or types of hardware and/or software.

Processor 1021 may be any type of circuitry that performs operations on behalf of wireless device 1010. In one embodiment, processor 1021 executes software (i.e., computer-readable instructions stored on a tangible computer-readable medium) that may include functionality related to LTE advanced location-sensitive information management methods and systems, for example. User interface module 1022 may be any type or combination of hardware and/or software that enables a user to operate and interact with wireless device 1010, and, in one embodiment, to interact with a system or software enabling the user to place, request, and/or receive calls, text communications of any type, voicemail, voicemail notifications, voicemail content and/or data, charging and/or billing data, and/or a system or software enabling the user to view, modify, or delete related software objects. For example, user interface module 1022 may include a display, physical and/or “soft” keys, voice recognition software, a microphone, a speaker and the like. Wireless communication module 1023 may be any type of transceiver including any combination of hardware and/or software that enables wireless device 1010 to communicate with wireless network equipment. Memory 1024 enables wireless device 1010 to store information, such as APNs, MNCs, MCCs, text communications content and associated data, multimedia content, software to efficiently process radio resource requests and service requests, and radio resource request processing preferences and configurations. Memory 1024 may take any form, such as internal random access memory (RAM), an SD card, a microSD card and the like. Power supply 1025 may be a battery or other type of power input (e.g., a charging cable that is connected to an electrical outlet, etc.) that is capable of powering wireless device 1010. SIM 1026 may be any type Subscriber Identity Module and may be configured on a removable or non-removable SIM card that allows wireless device 1010 to store data on SIM 1026.

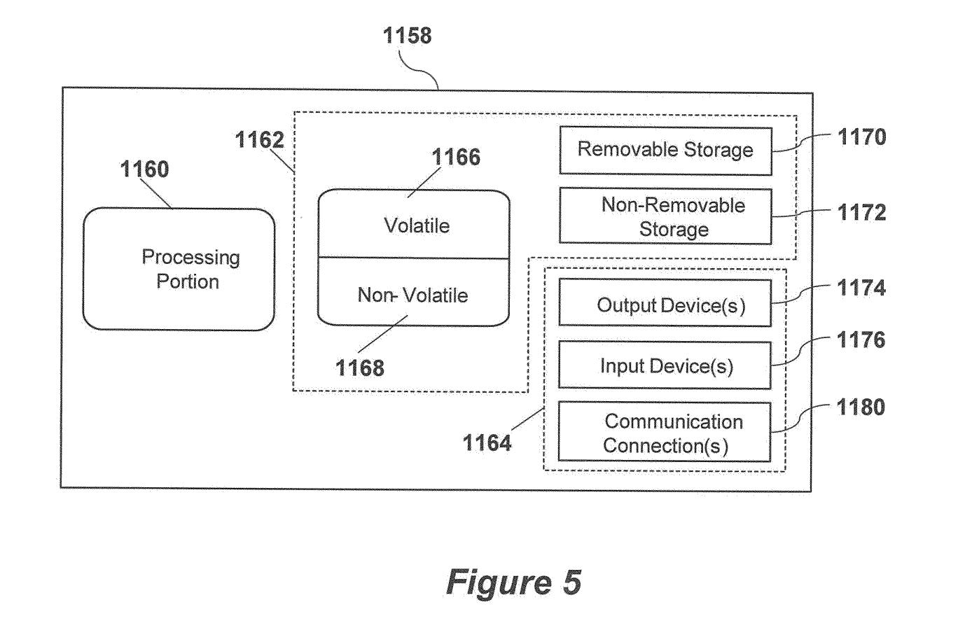

FIG. 5 is a block diagram of an example processor 1158 which may be employed in any of the embodiments described herein, including as one or more components of mobile devices 102 and 210, as one or more components of network equipment such as eNode-B 220, MME 230, PDN gateway 250, HLR/HSS 240, PCRF device 260, bandwidth manager 270, any other component of networks 106, 108, 110, 112, and 201, and/or any related equipment, and/or as one or more components of any third party system or subsystem that may implement any portion of the subject matter described herein. It is emphasized that the block diagram depicted in FIG. 5 is exemplary and not intended to imply a specific implementation. Thus, the processor 1158 can be implemented in a single processor or multiple processors. Multiple processors can be distributed or centrally located. Multiple processors can communicate wirelessly, via hard wire, or a combination thereof.

As depicted in FIG. 5, the processor 1158 comprises a processing portion 1160, a memory portion 1162, and an input/output portion 1164. The processing portion 1160, memory portion 1162, and input/output portion 1164 are coupled together (coupling not shown in FIG. 5) to allow communications between these portions. The input/output portion 1164 is capable of providing and/or receiving components, commands, and/or instructions, utilized to, for example, transmit and/or receive configuration data, transmit and receive device condition data, establish and terminate communications sessions, transmit and receive service requests and data access request data and responses, transmit, receive, store and process text, data, and voice communications, execute software that efficiently processes radio resource requests, receive and store service requests and radio resource requests, radio resource request processing preferences and configurations, and/or perform any other function described herein.

The processor 1158 may be implemented as a client processor and/or a server processor. In a basic configuration, the processor 1158 may include at least one processing portion 1160 and memory portion 1162. The memory portion 1162 can store any information utilized in conjunction with establishing, transmitting, receiving, and/or processing text, data, and/or voice communications, communications-related data and/or content, voice calls, other telephonic communications, etc. For example, the memory portion is capable of storing condition and event data, configuration commands, profiles, thresholds, APNs, MNCs, MCCs, service requests, radio resource requests, QoS and/or APN parameters, software for LTE advanced location-sensitive information management, device and link status, condition, and congestion data, text and data communications, calls, voicemail, multimedia content, visual voicemail applications, etc. Depending upon the exact configuration and type of processor, the memory portion 1162 can be volatile (such as RAM) 1166, non-volatile (such as ROM, flash memory, etc.) 1168, or a combination thereof. The processor 1158 can have additional features/functionality. For example, the processor 1158 may include additional storage (removable storage 1170 and/or non-removable storage 1172) including, but not limited to, magnetic or optical disks, tape, flash, smart cards or a combination thereof. Computer storage media, such as memory and storage elements 1162, 1170, 1172, 1166, and 1168, may be tangible storage media that may include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium that can be used to store the desired information and that can be accessed by the processor 1158. Any such computer storage media may be part of the processor 1158.

The processor 1158 may also contain the communications connection(s) 1180 that allow the processor 1158 to communicate with other devices, for example through a radio access network (RAN). Communications connection(s) 1180 is an example of communication media. Communication media typically embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection as might be used with a land line telephone, and wireless media such as acoustic, RF, infrared, cellular, and other wireless media. The term computer-readable media as used herein may include both storage media and communication media. The processor 1158 also may have input device(s) 1176 such as keyboard, keypad, mouse, pen, voice input device, touch input device, etc. Output device(s) 1174 such as a display, speakers, printer, etc. also may be included.

A RAN as described herein may comprise any telephony radio network, or any other type of communications network, wireline or wireless, or any combination thereof. The following description sets forth some exemplary telephony radio networks, such as the global system for mobile communications (GSM), and non-limiting operating environments. The below-described operating environments should be considered non-exhaustive, however, and thus the below-described network architectures merely show how LTE advanced location-sensitive information management methods and systems may be implemented with stationary and non-stationary network structures and architectures. It will be appreciated, however, that LTE advanced location-sensitive information management methods and systems as described herein may be incorporated with existing and/or future alternative architectures for communication networks as well.

The GSM is one of the most widely utilized wireless access systems in today's fast growing communication environment. The GSM provides circuit-switched data services to subscribers, such as mobile telephone or computer users. The General Packet Radio Service (GPRS), which is an extension to GSM technology, introduces packet switching to GSM networks. The GPRS uses a packet-based wireless communication technology to transfer high and low speed data and signaling in an efficient manner. The GPRS attempts to optimize the use of network and radio resources, thus enabling the cost effective and efficient use of GSM network resources for packet mode applications.

The exemplary GSM/GPRS environment and services described herein also may be extended to 3G services, such as Universal Mobile Telephone System (UMTS), Frequency Division Duplexing (FDD) and Time Division Duplexing (TDD), High Speed Packet Data Access (HSPDA), cdma2000 1x Evolution Data Optimized (EVDO), Code Division Multiple Access-2000 (cdma2000 3x), Time Division Synchronous Code Division Multiple Access (TD-SCDMA), Wideband Code Division Multiple Access (WCDMA), Enhanced Data GSM Environment (EDGE), International Mobile Telecommunications-2000 (IMT-2000), Digital Enhanced Cordless Telecommunications (DECT), 4G Services such as Long Term Evolution (LTE), LTE-Advanced. etc., as well as to other network services that become available in time. In this regard, LTE advanced location-sensitive information management methods and systems may be implemented independently of the method of data transport and does not depend on any particular network architecture or underlying protocols.

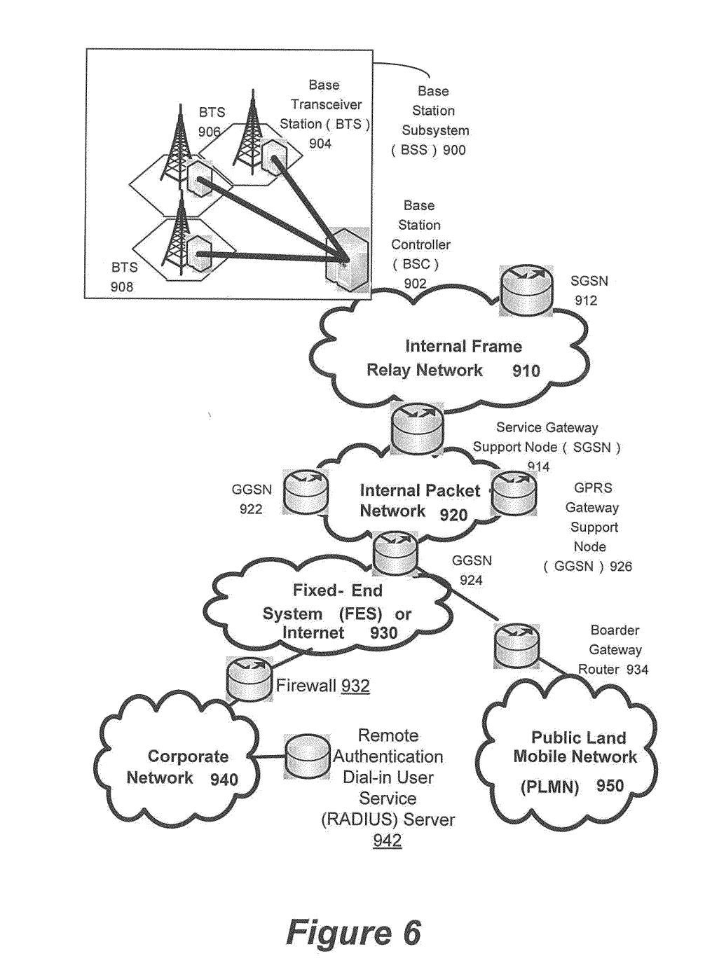

FIG. 6 depicts an overall block diagram of an exemplary packet-based mobile cellular network environment, such as a GPRS network, in which LTE advanced location-sensitive information management systems and methods such as those described herein may be practiced. In an example configuration, any RAN as described herein may be encompassed by or interact with the network environment depicted in FIG. 6. Similarly, mobile devices 102 and 210 may communicate or interact with a network environment such as that depicted in FIG. 6. In such an environment, there may be a plurality of Base Station Subsystems (BSS) 900 (only one is shown), each of which comprises a Base Station Controller (BSC) 902 serving a plurality of Base Transceiver Stations (BTS) such as BTSs 904, 906, and 908. BTSs 904, 906, 908, etc. are the access points where users of packet-based mobile devices (e.g., mobile devices 102 and 210) become connected to the wireless network. In exemplary fashion, the packet traffic originating from user devices (e.g., mobile devices 102 and 210) may be transported via an over-the-air interface to a BTS 908, and from the BTS 908 to the BSC 902. Base station subsystems, such as BSS 900, may be a part of internal frame relay network 910 that can include Service GPRS Support Nodes (SGSN) such as SGSN 912 and 914. Each SGSN may be connected to an internal packet network 920 through which a SGSN 912, 914, etc., may route data packets to and from a plurality of gateway GPRS support nodes (GGSN) 922, 924, 926, etc. As illustrated, SGSN 914 and GGSNs 922, 924, and 926 may be part of internal packet network 920. Gateway GPRS serving nodes 922, 924 and 926 may provide an interface to external Internet Protocol (IP) networks, such as Public Land Mobile Network (PLMN) 950, corporate intranets 940, or Fixed-End System (FES) or the public Internet 930. As illustrated, subscriber corporate network 940 may be connected to GGSN 924 via firewall 932, and PLMN 950 may be connected to GGSN 924 via border gateway router 934. The Remote Authentication Dial-In User Service (RADIUS) server 942 may be used for caller authentication when a user of a mobile cellular device calls corporate network 940.

Generally, there may be four different cell sizes in a GSM network, referred to as macro, micro, pico, and umbrella cells. The coverage area of each cell is different in different environments. Macro cells may be regarded as cells in which the base station antenna is installed in a mast or a building above average roof top level. Micro cells are cells whose antenna height is under average roof top level. Micro-cells may be typically used in urban areas. Pico cells are small cells having a diameter of a few dozen meters. Pico cells may be used mainly indoors. On the other hand, umbrella cells may be used to cover shadowed regions of smaller cells and fill in gaps in coverage between those cells.

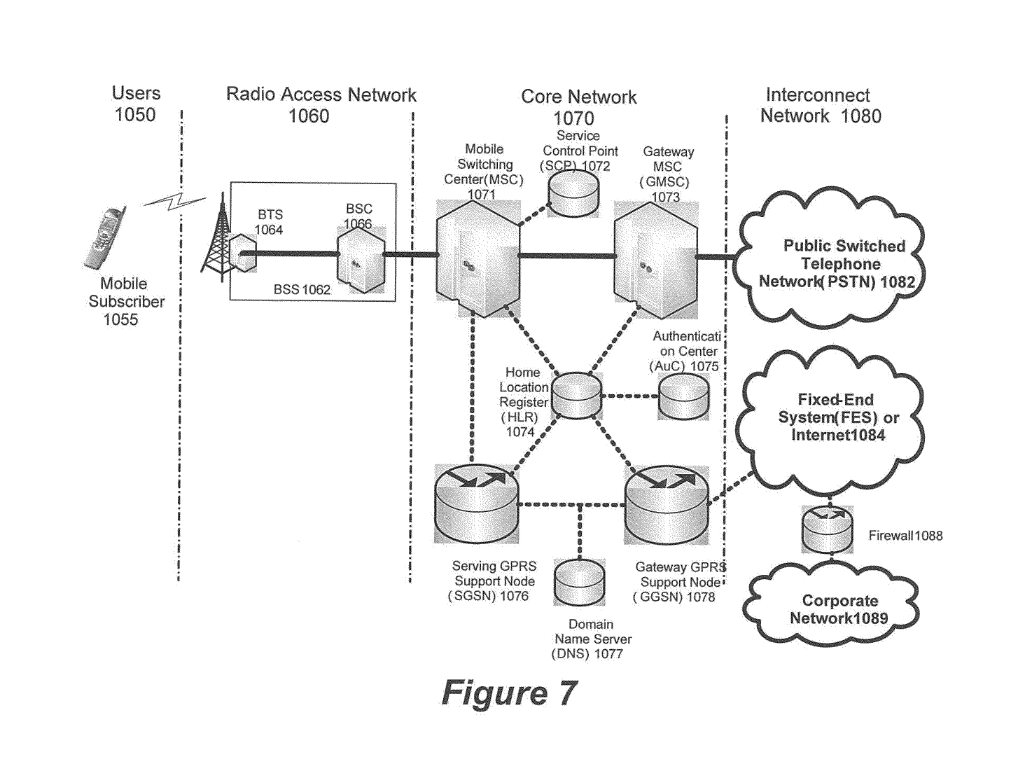

FIG. 7 illustrates an architecture of a typical GPRS network segmented into four groups: users 1050, radio access network 1060, core network 1070, and interconnect network 1080. Users 1050 may comprise a plurality of end users (although only mobile subscriber 1055 is shown in FIG. 7). In an example embodiment, the device depicted as mobile subscriber 1055 may comprise any of mobile devices 102 and 210. Radio access network 1060 comprises a plurality of base station subsystems such as BSSs 1062, which include BTSs 1064 and BSCs 1066. Core network 1070 comprises a host of various network elements. As illustrated here, core network 1070 may comprise Mobile Switching Center (MSC) 1071, Service Control Point (SCP) 1072, gateway MSC 1073, SGSN 1076, Home Location Register (HLR) 1074, Authentication Center (AuC) 1075, Domain Name Server (DNS) 1077, and GGSN 1078. Interconnect network 1080 may also comprise a host of various networks and other network elements. As illustrated in FIG. 7, interconnect network 1080 comprises Public Switched Telephone Network (PSTN) 1082, Fixed-End System (FES) or Internet 1084, firewall 1088, and Corporate Network 1089.

A mobile switching center may be connected to a large number of base station controllers. At MSC 1071, for instance, depending on the type of traffic, the traffic may be separated in that voice may be sent to Public Switched Telephone Network (PSTN) 1082 through Gateway MSC (GMSC) 1073, and/or data may be sent to SGSN 1076 that may send the data traffic to GGSN 1078 for further forwarding.

When MSC 1071 receives call traffic, for example, from BSC 1066, it may send a query to a database hosted by SCP 1072. The SCP 1072 may process the request and may issue a response to MSC 1071 so that it may continue call processing as appropriate.

The HLR 1074 may be a centralized database for users to register to the GPRS network. In some embodiments, HLR/HSS 240 may be a device such as HLR 1074. HLR 1074 may store static information about the subscribers such as the International Mobile Subscriber Identity (IMSI), APN profiles, profiles as disclosed herein, subscribed services, and a key for authenticating the subscriber. HLR 1074 may also store dynamic subscriber information such as dynamic APN profiles and the current location of the mobile subscriber. HLR 1074 may also serve to intercept and determine the validity of destination numbers in messages sent from a device, such as mobile subscriber 1055, as described herein. Associated with HLR 1074 may be AuC 1075. AuC 1075 may be a database that contains the algorithms for authenticating subscribers and may include the associated keys for encryption to safeguard the user input for authentication.

In the following, depending on context, the term “mobile subscriber” sometimes refers to the end user and sometimes to the actual portable device, such as mobile devices 102 and 210, used by an end user of a mobile cellular service or a wireless provider. When a mobile subscriber turns on his or her mobile device, the mobile device may go through an attach process by which the mobile device attaches to an SGSN of the GPRS network. In FIG. 7, when mobile subscriber 1055 initiates the attach process by turning on the network capabilities of the mobile device, an attach request may be sent by mobile subscriber 1055 to SGSN 1076. The SGSN 1076 queries another SGSN, to which mobile subscriber 1055 was attached before, for the identity of mobile subscriber 1055. Upon receiving the identity of mobile subscriber 1055 from the other SGSN, SGSN 1076 may request more information from mobile subscriber 1055. This information may be used to authenticate mobile subscriber 1055 to SGSN 1076 by HLR 1074. Once verified, SGSN 1076 sends a location update to HLR 1074 indicating the change of location to a new SGSN, in this case SGSN 1076. HLR 1074 may notify the old SGSN, to which mobile subscriber 1055 was attached before, to cancel the location process for mobile subscriber 1055. HLR 1074 may then notify SGSN 1076 that the location update has been performed. At this time, SGSN 1076 sends an Attach Accept message to mobile subscriber 1055, which in turn sends an Attach Complete message to SGSN 1076.

After attaching itself to the network, mobile subscriber 1055 may then go through the authentication process. In the authentication process, SGSN 1076 may send the authentication information to HLR 1074, which may send information back to SGSN 1076 based on the user profile that was part of the user's initial setup. The SGSN 1076 may then send a request for authentication and ciphering to mobile subscriber 1055. The mobile subscriber 1055 may use an algorithm to send the user identification (ID) and password to SGSN 1076. The SGSN 1076 may use the same algorithm and compares the result. If a match occurs, SGSN 1076 authenticates mobile subscriber 1055.

Next, the mobile subscriber 1055 may establish a user session with the destination network, corporate network 1089, by going through a Packet Data Protocol (PDP) activation process. Briefly, in the process, mobile subscriber 1055 may request access to an Access Point Name (APN), for example, UPS.com, and SGSN 1076 may receive the activation request from mobile subscriber 1055. SGSN 1076 may then initiate a Domain Name Service (DNS) query to learn which GGSN node has access to the UPS.com APN. The DNS query may be sent to the DNS server within the core network 1070, such as DNS 1077, which may be provisioned to map to one or more GGSN nodes in the core network 1070. Based on the APN, the mapped GGSN 1078 may access the requested corporate network 1089. The SGSN 1076 may then send to GGSN 1078 a Create Packet Data Protocol (PDP) Context Request message that contains necessary information. The GGSN 1078 may send a Create PDP Context Response message to SGSN 1076, which may then send an Activate PDP Context Accept message to mobile subscriber 1055.

Once activated, data packets of the call made by mobile subscriber 1055 may then go through radio access network 1060, core network 1070, and interconnect network 1080, in a particular fixed-end system, or Internet 1084 and firewall 1088, to reach corporate network 1089.

Thus, network elements that can invoke the functionality of LTE advanced location-sensitive information management methods and systems such as those described herein may include, but are not limited to, Gateway GPRS Support Node tables, Fixed End System router tables, firewall systems, VPN tunnels, and any number of other network elements as required by the particular digital network.

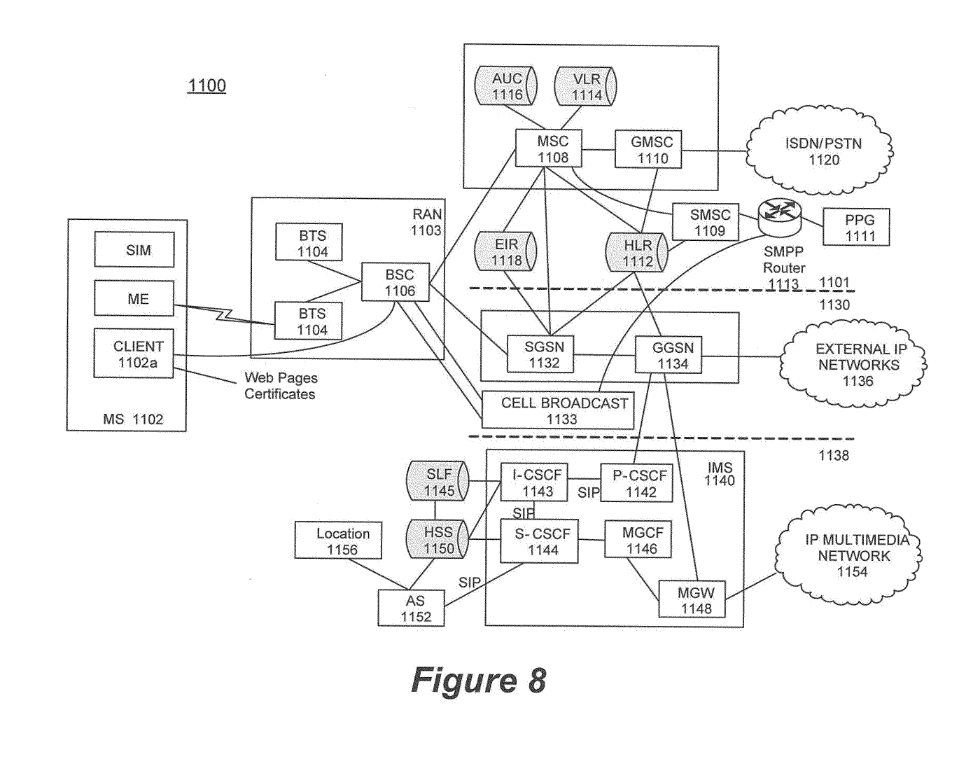

FIG. 8 illustrates another exemplary block diagram view of a GSM/GPRS/IP multimedia network architecture 1100 in which the systems and methods for LTE advanced location-sensitive information management methods and systems such as those described herein may be incorporated. As illustrated, architecture 1100 of FIG. 8 includes a GSM core network 1101, a GPRS network 1130 and an IP multimedia network 1138. The GSM core network 1101 includes a Mobile Station (NIS) 1102, at least one Base Transceiver Station (BTS) 1104 and a Base Station Controller (BSC) 1106. The MS 1102 is physical equipment or Mobile Equipment (ME), such as a mobile telephone or a laptop computer (e.g., mobile devices 102 and 210) that is used by mobile subscribers, in one embodiment with a Subscriber identity Module (SIM). The SIM may include an International Mobile Subscriber Identity (IMSI), which may be a unique identifier of a subscriber. The SIM may also include APNs. The BTS 1104 may be physical equipment, such as a radio tower, that enables a radio interface to communicate with the MS. Each BTS may serve more than one MS. The BSC 1106 may manage radio resources, including the BTS. The BSC may be connected to several BTSs. The BSC and BTS components, in combination, are generally referred to as a base station (BSS) or radio access network (RAN) 1103.

The GSM core network 1101 may also include a Mobile Switching Center (MSC) 1108, a Gateway Mobile Switching Center (GMSC) 1110, a Home Location Register (HLR) 1112, Visitor Location Register (VLR) 1114, an Authentication Center (AuC) 1118, and an Equipment Identity Register (EIR) 1116. The MSC 1108 may perform a switching function for the network. The MSC may also perform other functions, such as registration, authentication, location updating, handovers, and call routing. The GMSC 1110 may provide a gateway between the GSM network and other networks, such as an Integrated Services Digital Network (ISDN) or Public Switched Telephone Networks (PSTNs) 1120. Thus, the GMSC 1110 provides interworking functionality with external networks.

The HLR 1112 may be a database that may contain administrative information regarding each subscriber registered in a corresponding GSM network. Such information may include APNs and APN profiles. The HLR 1112 may also contain the current location of each MS. The VLR 1114 may be a database that contains selected administrative information from the HLR 1112. The VLR may contain information necessary for call control and provision of subscribed services for each MS currently located in a geographical area controlled by the VLR. The HLR 1112 and the VLR 1114, together with the MSC 1108, may provide the call routing and roaming capabilities of GSM. The AuC 1116 may provide the parameters needed for authentication and encryption functions. Such parameters allow verification of a subscriber's identity. The EIR 1118 may store security-sensitive information about the mobile equipment.

A Short Message Service Center (SMSC) 1109 allows one-to-one short message service (SMS), or multimedia message service (MMS), messages to be sent to/from the MS 1102. A Push Proxy Gateway (PPG) 1111 is used to “push” (i.e., send without a synchronous request) content to the MS 1102. The PPG 1111 acts as a proxy between wired and wireless networks to facilitate pushing of data to the MS 1102. A Short Message Peer to Peer (SMPP) protocol router 1113 may be provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as voice, data, short message service (SMS), and multimedia message service (MMS), the MS may first register with the network to indicate its current location by performing a location update and IMSI attach procedure. MS 1102 may send a location update including its current location information to the MSC/VLR, via BTS 1104 and BSC 1106. The location information may then be sent to the MS's HLR. The HLR may be updated with the location information received from the MSC/VLR. The location update may also be performed when the MS moves to a new location area. Typically, the location update may be periodically performed to update the database as location updating events occur.

GPRS network 1130 may be logically implemented on the GSM core network architecture by introducing two packet-switching network nodes, a serving GPRS support node (SGSN) 1132, a cell broadcast and a Gateway GPRS support node (GGSN) 1134. The SGSN 1132 may be at the same hierarchical level as the MSC 1108 in the GSM network. The SGSN may control the connection between the GPRS network and the MS 1102. The SGSN may also keep track of individual MS's locations and security functions and access controls.

Cell Broadcast Center (CBC) 1133 may communicate cell broadcast messages that are typically delivered to multiple users in a specified area. Cell Broadcast is one-to-many geographically focused service. It enables messages to be communicated to multiple mobile telephone customers who are located within a given part of its network coverage area at the time the message is broadcast.

GGSN 1134 may provide a gateway between the GPRS network and a public packet network (PDN) or other IP networks 1136. That is, the GGSN may provide interworking functionality with external networks, and set up a logical link to the MS through the SGSN. When packet-switched data leaves the GPRS network, it may be transferred to an external TCP-IP network 1136, such as an X.25 network or the Internet. In order to access GPRS services, the MS first attaches itself to the GPRS network by performing an attach procedure. The MS may then activate a packet data protocol (PDP) context, thus activating a packet communication session between the MS, the SGSN, and the GGSN.

In a GSM/GPRS network, GPRS services and GSM services may be used in parallel. The MS may operate in one three classes: class A, class B, and class C. A class A MS may attach to the network for both GPRS services and GSM services simultaneously. A class A MS may also support simultaneous operation of GPRS services and GSM services. For example, class A mobiles may receive GSM voice/data/SMS calls and GPRS data calls at the same time.

A class B MS may attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

GPRS network 1130 may be designed to operate in three network operation modes (NOM1, NOM2 and NOM3). A network operation mode of a GPRS network may be indicated by a parameter in system information messages transmitted within a cell. The system information messages may direct an MS where to listen for paging messages and how to signal towards the network. The network operation mode represents the capabilities of the GPRS network. In a NOM1 network, a MS may receive pages from a circuit switched domain (voice call) when engaged in a data call. The MS may suspend the data call or take both simultaneously, depending on the ability of the MS. In a NOM2 network, a MS may not receive pages from a circuit switched domain when engaged in a data call, since the MS may be receiving data and may not be listening to a paging channel. In a NOM3 network, a MS may monitor pages for a circuit switched network while receiving data and vice versa.

The IP multimedia network 1138 was introduced with 3GPP Release 5, and may include IP multimedia subsystem (IMS) 1140 to provide rich multimedia services to end users. A representative set of the network entities within IMS 1140 are a call/session control function (CSCF), a media gateway control function (MGCF) 1146, a media gateway (MGW) 1148, and a master subscriber database, called a home subscriber server (HSS) 1150. HSS 1150 may be common to GSM core network 1101, GPRS network 1130 as well as IP multimedia network 1138.

IP multimedia system 1140 may be built around the call/session control function, of which there are three types: an interrogating CSCF (I-CSCF) 1143, a proxy CSCF (P-CSCF) 1142, and a serving CSCF (S-CSCF) 1144. The P-CSCF 1142 is the MS's first point of contact with the IMS 1140. The P-CSCF 1142 may forward session initiation protocol (SIP) messages received from the MS to an SIP server in a home network (and vice versa) of the MS. The P-CSCF 1142 may also modify an outgoing request according to a set of rules defined by the network operator (for example, address analysis and potential modification).

I-CSCF 1143 forms an entrance to a home network and hides the inner topology of the home network from other networks and provides flexibility for selecting an S-CSCF. I-CSCF 1143 may contact subscriber location function (SLF) 1145 to determine which HSS 1150 to use for the particular subscriber, if multiple HSSs 1150 are present. S-CSCF 1144 may perform the session control services for MS 1102. This includes routing originating sessions to external networks and routing terminating sessions to visited networks. S-CSCF 1144 may also decide whether an application server (AS) 1152 is required to receive information on an incoming SIP session request to ensure appropriate service handling. This decision may be based on information received from HSS 1150 (or other sources, such as application server 1152). AS 1152 may also communicate to location server 1156 (e.g., a Gateway Mobile Location Center (GMLC)) that provides a position (e.g., latitude/longitude coordinates) of MS 1102.

HSS 1150 may contain a subscriber profile and keep track of which core network node is currently handling the subscriber. It may also support subscriber authentication and authorization functions (AAA). In networks with more than one HSS 1150, a subscriber location function provides information on the HSS 1150 that contains the profile of a given subscriber.

MGCF 1146 may provide interworking functionality between SIP session control signaling from the IMS 1140 and ISUP/BICC call control signaling from the external GSTN networks (not shown.) It may also control the media gateway (MGW) 1148 that provides user-plane interworking functionality (e.g., converting between AMR- and PCM-coded voice.) MGW 1148 may also communicate with other IP multimedia networks 1154.

Push to Talk over Cellular (PoC) capable mobile telephones may register with the wireless network when the telephones are in a predefined area (e.g., job site, etc.) When the mobile telephones leave the area, they may register with the network in their new location as being outside the predefined area. This registration, however, does not indicate the actual physical location of the mobile telephones outside the pre-defined area.

While example embodiments of LTE advanced location-sensitive information management methods and systems have been described in connection with various communications devices and computing devices and processors, the underlying concepts can be applied to any communications or computing device, processor, or system capable of implementing the LTE advanced location-sensitive information management methods and systems described. The various techniques described herein may be implemented in connection with hardware or software or, where appropriate, with a combination of both. The methods and apparatuses for LTE advanced location-sensitive information management, or certain aspects or portions thereof, can take the form of program code (i.e., instructions) embodied in tangible and/or other media that is not a signal (i.e., not a transient signal per se, not a propagating signal per se) such as floppy diskettes, CD-ROMs, hard drives, or any other machine-readable storage medium, wherein, when the program code is loaded into and executed by a machine, such as a computer, the machine becomes an apparatus for LTE advanced location-sensitive information management. In the case of program code execution on programmable computers, the computing device may include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

Methods and systems for LTE advanced location-sensitive information management may also be practiced via communications embodied in the form of program code that may be transmitted over some transmission medium, such as over electrical wiring or cabling, through fiber optics, or via any other form of transmission, wherein, when the program code is received, loaded into, and executed by a machine, such as an EPROM, a gate array, a programmable logic device (PLD), a client computer, or the like, the machine becomes an apparatus for LTE advanced location-sensitive information management. When implemented on a general-purpose processor, the program code combines with the processor to provide a unique apparatus that operates to invoke the functionality of LTE advanced location-sensitive information management as described herein. Additionally, any storage techniques used in connection with a LTE advanced location-sensitive information management system may be a combination of hardware and software.

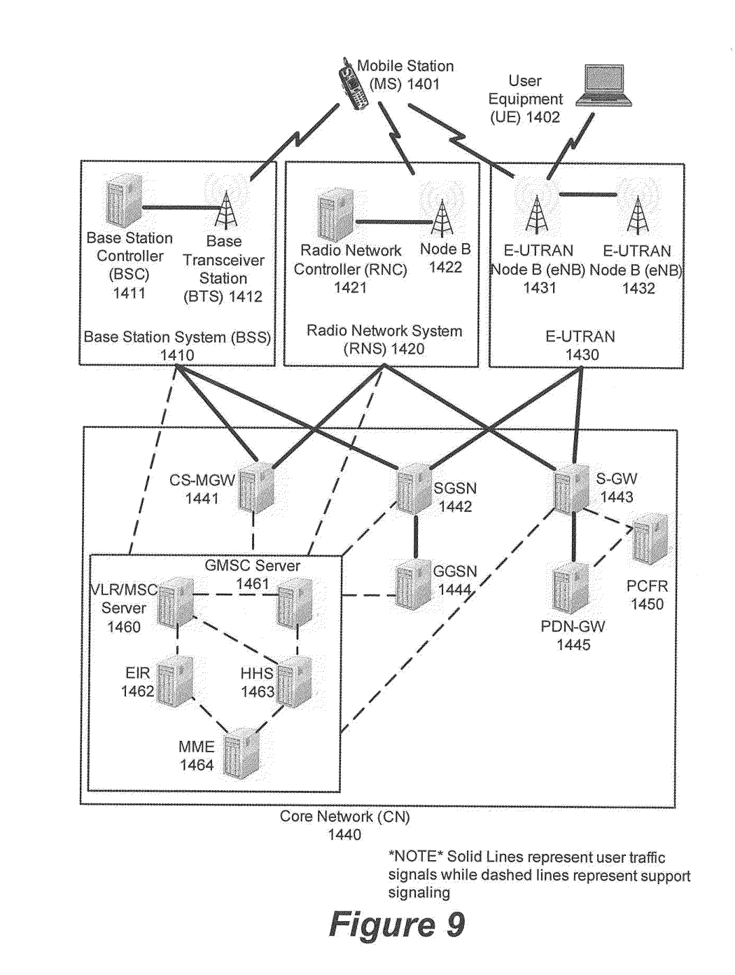

FIG. 9 illustrates a PLMN block diagram view of an example architecture in which text message generation for emergency services as a backup to voice communications may be incorporated. Mobile Station (MS) 1401 is the physical equipment used by the PLMN subscriber. In one illustrative embodiment, communications device 200 may serve as Mobile Station 1401. Mobile Station 1401 may be one of, but not limited to, a cellular telephone, a cellular telephone in combination with another electronic device or any other wireless mobile communication device.

Mobile Station 1401 may communicate wirelessly with Base Station System (BSS) 1410. BSS 1410 contains a Base Station Controller (BSC) 1411 and a Base Transceiver Station (BTS) 1412. BSS 1410 may include a single BSC 1411/BTS 1412 pair (Base Station) or a system of BSC/BTS pairs which are part of a larger network. BSS 1410 is responsible for communicating with Mobile Station 1401 and may support one or more cells. BSS 1410 is responsible for handling cellular traffic and signaling between Mobile Station 1401 and Core Network 1440. Typically, BSS 1410 performs functions that include, but are not limited to, digital conversion of speech channels, allocation of channels to mobile devices, paging, and transmission/reception of cellular signals.

Additionally, Mobile Station 1401 may communicate wirelessly with Radio Network System (RNS) 1420. RNS 1420 contains a Radio Network Controller (RNC) 1421 and one or more Node(s) B 1422. RNS 1420 may support one or more cells. RNS 1420 may also include one or more RNC 1421/Node B 1422 pairs or alternatively a single RNC 1421 may manage multiple Nodes B 1422. RNS 1420 is responsible for communicating with Mobile Station 1401 in its geographically defined area. RNC 1421 is responsible for controlling the Node(s) B 1422 that are connected to it and is a control element in a UMTS radio access network. RNC 1421 performs functions such as, but not limited to, load control, packet scheduling, handover control, security functions, as well as controlling Mobile Station 1401's access to the Core Network (CN) 1440.

The evolved UMTS Terrestrial Radio Access Network (E-UTRAN) 1430 is a radio access network that provides wireless data communications for Mobile Station 1401 and User Equipment 1402. E-UTRAN 1430 provides higher data rates than traditional UMTS. It is part of the Long Term Evolution (LTE) upgrade for mobile networks and later releases meet the requirements of the International Mobile Telecommunications (IMT) Advanced and are commonly known as a 4G networks. E-UTRAN 1430 may include of series of logical network components such as E-UTRAN Node B (eNB) 1431 and E-UTRAN Node B (eNB) 1432. E-UTRAN 1430 may contain one or more eNBs. User Equipment 1402 may be any user device capable of connecting to E-UTRAN 1430 including, but not limited to, a personal computer, laptop, mobile device, wireless router, or other device capable of wireless connectivity to E-UTRAN 1430. The improved performance of the E-UTRAN 1430 relative to a typical UMTS network allows for increased bandwidth, spectral efficiency, and functionality including, but not limited to, voice, high-speed applications, large data transfer and IPTV, while still allowing for full mobility.

An example embodiment of a mobile data and communication service that may be implemented in the PLMN architecture described in FIG. 9 is the Enhanced Data rates for GSM Evolution (EDGE). EDGE is an enhancement for GPRS networks that implements an improved signal modulation scheme known as 8-PSK (Phase Shift Keying). By increasing network utilization, EDGE may achieve up to three times faster data rates as compared to a typical GPRS network. EDGE may be implemented on any GSM network capable of hosting a GPRS network, making it an ideal upgrade over GPRS since it may provide increased functionality of existing network resources. Evolved EDGE networks are becoming standardized in later releases of the radio telecommunication standards, which provide for even greater efficiency and peak data rates of up to 1 Mbit/s, while still allowing implementation on existing GPRS-capable network infrastructure.

Typically Mobile Station 1401 may communicate with any or all of BSS 1410, RNS 1420, or E-UTRAN 1430. In a illustrative system, each of BSS 1410, RNS 1420, and E-UTRAN 1430 may provide Mobile Station 1401 with access to Core Network 1440. The Core Network 1440 may include of a series of devices that route data and communications between end users. Core Network 1440 may provide network service functions to users in the Circuit Switched (CS) domain, the Packet Switched (PS) domain or both. The CS domain refers to connections in which dedicated network resources are allocated at the time of connection establishment and then released when the connection is terminated. The PS domain refers to communications and data transfers that make use of autonomous groupings of bits called packets. Each packet may be routed, manipulated, processed or handled independently of all other packets in the PS domain and does not require dedicated network resources.

The Circuit Switched—Media Gateway Function (CS-MGW) 1441 is part of Core Network 1440, and interacts with Visitor Location Register (VLR) and Mobile-Services Switching Center (MSC) Server 1460 and Gateway MSC Server 1461 in order to facilitate Core Network 1440 resource control in the CS domain. Functions of CS-MGW 1441 include, but are not limited to, media conversion, bearer control, payload processing and other mobile network processing such as handover or anchoring. CS-MGW 1440 may receive connections to Mobile Station 1401 through BSS 1410, RNS 1420 or both.

Serving GPRS Support Node (SGSN) 1442 stores subscriber data regarding Mobile Station 1401 in order to facilitate network functionality. SGSN 1442 may store subscription information such as, but not limited to, the International Mobile Subscriber Identity (IMSI), temporary identities, or Packet Data Protocol (PDP) addresses. SGSN 1442 may also store location information such as, but not limited to, the Gateway GPRS Support Node (GGSN) 1444 address for each GGSN where an active PDP exists. GGSN 1444 may implement a location register function to store subscriber data it receives from SGSN 1442 such as subscription or location information.

Serving Gateway (S-GW) 1443 is an interface which provides connectivity between E-UTRAN 1430 and Core Network 1440. Functions of S-GW 1443 include, but are not limited to, packet routing, packet forwarding, transport level packet processing, event reporting to Policy and Charging Rules Function (PCRF) 1450, and mobility anchoring for inter-network mobility. PCRF 1450 uses information gathered from S-GW 1443, as well as other sources, to make applicable policy and charging decisions related to data flows, network resources and other network administration functions. Packet Data Network Gateway (PDN-GW) 1445 may provide user-to-services connectivity functionality including, but not limited to, network-wide mobility anchoring, bearer session anchoring and control, and IP address allocation for PS domain connections.

Home Subscriber Server (HSS) 1463 is a database for user information, and stores subscription data regarding Mobile Station 1401 or User Equipment 1402 for handling calls or data sessions. Networks may contain one HSS 1463 or more if additional resources are required. Example data stored by HSS 1463 include, but is not limited to, user identification, numbering and addressing information, security information, or location information. HSS 1463 may also provide call or session establishment procedures in both the PS and CS domains.

The VLR/MSC Server 1460 provides user location functionality. When Mobile Station 1401 enters a new network location, it begins a registration procedure. A MSC Server for that location transfers the location information to the VLR for the area. A VLR and MSC Server may be located in the same computing environment, as is shown by VLR/MSC Server 1460, or alternatively may be located in separate computing environments. A VLR may contain, but is not limited to, user information such as the IMSI, the Temporary Mobile Station Identity (TMST), the Local Mobile Station Identity (LMSI), the last known location of the mobile station, or the SGSN where the mobile station was previously registered. The MSC server may contain information such as, but not limited to, procedures for Mobile Station 1401 registration or procedures for handover of Mobile Station 1401 to a different section of the Core Network 1440. GMSC Server 1461 may serve as a connection to alternate GMSC Servers for other mobile stations in larger networks.

Equipment Identity Register (EIR) 1462 is a logical element which may store the International Mobile Equipment Identities (IMEI) for Mobile Station 1401. In a typical embodiment, user equipment may be classified as either “white listed” or “black listed” depending on its status in the network. In one embodiment, if Mobile Station 1401 is stolen and put to use by an unauthorized user, it may be registered as “black listed” in EIR 1462, preventing its use on the network. Mobility Management Entity (MME) 1464 is a control node which may track Mobile Station 1401 or User Equipment 1402 if the devices are idle. Additional functionality may include the ability of MME 1464 to contact an idle Mobile Station 1401 or User Equipment 1402 if retransmission of a previous session is required.

While LTE advanced location-sensitive information management methods and systems have been described in connection with the various embodiments of the various figures, it is to be understood that other similar embodiments may be used or modifications and additions may be made to the described embodiments for performing the same function of LTE advanced location-sensitive information management without deviating therefrom. For example, one skilled in the art will recognize LTE advanced location-sensitive information management as described in the present application may apply to any environment, whether wired or wireless, and may be applied to any number of such devices connected via a communications network and interacting across the network. Therefore, LTE advanced location-sensitive information management methods and systems should not be limited to any single embodiment, but rather should be construed in breadth and scope in accordance with the appended claims.

I claim:

1. A method comprising:
receiving, by a server, location information corresponding to a location of a device that is remote from the server;
the server further receiving identification information corresponding to a user of the device;
categorizing, by the server, the location information based on the identification information;
receiving, by the server, a list of one or more intended recipients of the location information; and
during a first time duration, providing, by the server, the location information, wherein the list of one or more intended recipients is indicative of one or more intended recipients of the provided location information.

2. The method of claim 1, wherein receiving the location information comprises receiving updated location information for the device.

3. The method of claim 1, further comprising:
receiving, by the server, a query seeking permission to access the location information.

4. The method of claim 1, further comprising:
receiving, by the server, a query seeking permission to share the location information.

5. The method of claim 1, wherein providing the location information during the first time duration is responsive to a request to provide the location information.

6. The method of claim 1, wherein the server further comprises a privacy feature permitting the user, at the user's request, to enable or disable sending the location information to other users.

7. The method of claim 1, wherein the server further comprises multiple user location information, and the server further comprises a sharing feature permitting multiple users to share the multiple user location information with other of the multiple users, with the mutual consent of each multiple user.

8. The method of claim 1, further comprising the server receiving confirmation from the user, whereupon the server starts sending the location information during the first time duration, and further comprising the server receiving a cancellation instruction from the user, whereupon the server stops sending the location information during the first time duration.

9. The method of claim 6, further comprising the server receiving a confirmation from the user, whereupon the server disables the privacy feature and starts sending the location information, and further comprising the server receiving a cancellation instruction from the user, whereupon the server turns on the privacy feature and stops sending the location information.

10. The method of claim 1, further comprising the server receiving a query from the user seeking permission to access location information of a second user, wherein upon receiving confirmation from the second user, the server starts sending the second user's location information to the user, and wherein upon receiving a cancellation instruction from the second user, the server stops sending the second user's location information to the user.

11. The method of claim 1, wherein the user is selected from the group comprising law enforcement, emergency rescue, EMT, and medical personnel, and at least one of the one or more intended recipients is a nonresponsive subscriber or is a suspected perpetrator of criminal activity, and wherein the server sends the user the location information of the nonresponsive subscriber or suspected perpetrator of criminal activity.

12. The method of claim 6, wherein the server further includes a privacy override feature enabling the server to override the privacy feature and send the user a location of at least one of the one or more intended recipients.

13. The method of claim 11, wherein the server recommends a time duration for exposing the location information of the at least one of the one or more intended recipients for a time window during which criminal activity or medical emergency situations are likely to occur.

14. A device comprising:
a subscriber location information module;
a subscriber profile module; and
a time duration module including a start time and an end time, the time duration feature enabling, at the start time, the device to send, based on the subscriber profile feature, a subscriber's location information to one or more intended recipients, and further enabling, at the end time, the device to discontinue sending the subscriber's location information to the one or more intended recipients.

15. A computer-readable storage medium comprising executable instructions that when executed by a processor cause the processor to effectuate operations comprising:
receiving, by a server, location information corresponding to a location of a device that is remote from the server, and further receiving identification information corresponding to a user of the device;
categorizing, by the server, the location information based on the identification information;
receiving, by the server, a list of one or more intended recipients;
recommending, by the server, based on the identification information, a time duration during which to expose the location information to the list of one or more intended recipients, based on the identification information; and
sending, by the server during the time duration, the location information to the list of one or more intended recipients.

16. The method of claim 1, wherein the server is in communication with an LTE network, the server comprising a database comprising stored identification information and updated location information; the database further comprising stored time sensitive data associated with the user, whereby the server may recommend, based on the time sensitive data, a time duration during which the LTE network may expose the updated location information, based on the user's identification information, to one or more intended recipients.

17. The method of claim 16, wherein the server further comprises a machine-to-machine controller in communication with the LTE network, the machine-to-machine controller comprising a trigger that may initiate the machine-to-machine controller sending the time sensitive data, at a predetermined time, to the one or more intended recipients through the LTE network.

18. The system of claim 17 further comprising:
a home network comprising a first LTE network in communication with a plurality of home devices, the machine-to-machine controller in communication with the first LTE network, the machine-to-machine controller comprising a trigger that may initiate the machine-to-machine controller sending time sensitive data, at a predetermined time, to one or more of the plurality of home devices through the first LTE network;
a remote network comprising a second LTE network which may be the same or different from the first LTE network, the second LTE network in communication with a plurality of remote devices; and
an aggregator in communication with both the first LTE network and the second LTE network, wherein the aggregator may aggregate data from the plurality of home devices to yield aggregated data, and may deliver the aggregated data to one or more of the remote devices.
